(19) United States
(12) Patent Application Publication
(10) Pub. No.: US 2012/0047187 A1
(43) Pub. Date: Feb. 23, 2012

(54) SYSTEM FOR MULTI-PHASE MANAGEMENT OF A NATURAL DISASTER INCIDENT

(76) Inventor: Steven J. Daus, Sunnyvale, CA (US)

(21) Appl. No.: 12/858,356

(22) Filed: Aug. 17, 2010

(51) Int. Cl. G06F 17/30

(52) U.S. Cl. 707/805; 707/E17.005

(57) ABSTRACT

A computerized system for multi-phase management of a natural disaster incident is disclosed. In one embodiment of the invention, the computerized system incorporates a pre-incident risk reduction management module, a crisis response management module, and a restoration and rehabilitation management module to correspond to these three distinct phases of managing a natural disaster incident. This multi-phase natural disaster management system can be utilized by private entities, community groups, state, national, and/or international agencies to assist prevention or reduction of damage to human and natural resources in a particular disaster incident. Furthermore, the multi-phase natural disaster management system can assist or enable protection of lives, health, and safety of community members and disaster incident response personnel. A prioritization model in the pre-incident risk management module can take an empirical or subjective weighting factor in evaluating a particular geographic section to optimize disaster prevention and management.

### BACKGROUND OF THE INVENTION

1. Field of the Invention

This invention generally relates to natural disaster risk-reduction and management. More specifically, the invention relates to a novel computerized system for multi-phase management of a natural disaster incident.

2. Description of Related Art

In most state, municipal, and private entities today, natural disaster management is typically carried out by underfunded or underprepared agencies in an ad-hoc, on-demand, and/or case-by-case basis. For example, a state government may allocate more financial and human resources to a firefighting agency responsible for managing a wildfire only when the wildfire newly erupts in a dry season. Similarly, any significant information technology (IT) infrastructure may be allocated and utilized significantly only when a particular natural disaster incident requires the use of such IT resources.

As more people relocate or get exposed to natural areas and wildlife zones, there is more likelihood of a larger impact of natural disasters on those people. The number of human lives and assets at risk is growing steadily not only for residents of a potentially dangerous area but also for the emergency personnel coming to their aid. Although professional emergency services organizations attempt to be more organized, effective, and sometimes even more specialized to meet this growing challenge, one critical element for more effective management of both potential and ongoing natural disaster management may still be missing: the availability of complete and current information about the local tactical environment where the emergency response efforts are implemented.

As a case in point, when an emergency incident (e.g. a natural disaster incident) triggers a need for emergency response, decisions are made by a professional command and control organization, defined herein as an “incident command” (IC) group. As the emergency incident evolves, more resources and emergency personnel and equipment may be needed than what is available locally, which may prompt farther resources and even non-local emergency personnel to get involved. The non-local emergency personnel typically have little knowledge or experience with local conditions. Likewise, if decision makers responsible for deploying emergency resources and personnel are unfamiliar with particular local conditions, determining a specific response based on increasingly outdated and incomplete information as the emergency incident evolves presents a serious problem. Decisions made with outdated or incomplete information are less efficient and less effective at best, and at worst, increase the risk to lives, equipment, and property. In general, a higher level of preparation, planning, and up-to-date local information can reduce the potential risk, duration, and impact of the emergency incident.

Furthermore, the existing IT infrastructure for natural disaster management is generally more focused on crisis response management upon a disaster breakout than a preemptive disaster risk reduction management or a restoration and rehabilitation management. In addition, the current IT solutions for disaster management lack a broad, standardized, and scalable geographic database which allows risk reduction prioritization or post-incident (e.g. restoration/rehabilitation) management. If a natural disaster incident can be systematically and comprehensively managed as a lifecycle (e.g. a multi-phase systematic management starting from an incident prevention/preparation to a post-incident rehabilitation management after an outbreak of an incident), then the natural disaster management and response activities can be more efficiently coordinated and operated. Moreover, a standardized and scalable geographic database designed specifically for prioritization and optimization of natural disaster management can be beneficial for the operating effectiveness and the safety of emergency response personnel.

### SUMMARY

Summary and Abstract summarize some aspects of the present invention. Simplifications or omissions may have been made to avoid obscuring the purpose of the Summary or the Abstract. These simplifications or omissions are not intended to limit the scope of the present invention.

In one embodiment of the invention, a system for multi-phase management of a natural disaster incident is disclosed. This system comprises at least one CPU operatively connected to a memory unit; a pre-incident module operatively connected to a project-specific database (PSD) and a computer-readable storage medium, wherein the pre-incident module comprises a pre-incident module operating program, a pre-incident user interface, a prioritization model user interface, and a prioritization model program for a planning prioritization model, wherein the prioritization model program is capable of deriving a sub-area index value (SAIV), which is a quantitative measure of priority for pre-incident planning derived from an environmental parameter (EP), a weighting factor (WF) parameter, and a quantitative representation of the environmental parameter (QREP) for a specific area from the PSD; a crisis response module operatively connected to an incident-specific database (ISD) and the computer-readable storage medium, wherein the crisis response module comprises a crisis response module operating program, a crisis response module user interface, and an ISD update interface unit; and a rehabilitation management module operatively connected to the ISD and the computer-readable storage medium, wherein the rehabilitation management module comprises a rehabilitation management module operating program and a rehabilitation management module user interface.

Furthermore, in another embodiment of the invention, a data processing system for multi-phase management of a natural disaster incident is also disclosed. This data processing system comprises at least one CPU operatively connected to a memory unit; a pre-incident module operatively connected a project-specific database (PSD) and a computer readable storage medium, wherein the pre-incident module comprises a pre-incident module operating program, a pre-incident user interface, a prioritization model user interface, and a prioritization model program for a planning prioritization model, wherein the prioritization model program is capable of deriving a sub-area index value (SAIV), which is a quantitative measure of priority for pre-incident planning derived from an environmental parameter (EP), a weighting factor (WF) parameter, and a quantitative representation of the environmental parameter (QREP) for a specific area from the PSD; a crisis response module operatively connected to an incident-specific database (ISD) and the computer readable storage medium, wherein the crisis response module comprises a crisis response module operating program, a crisis response module user interface, and an ISD update interface unit; a rehabilitation management module operatively connected to the ISD and the computer readable storage medium, wherein the rehabilitation management module comprises a rehabilitation management module operating program and a rehabilitation management module user interface; and an ISD update unit which receives and authenticates an ISD update request from a user and processes the ISD update request by updating an operational version of the ISD and storing a record of the ISD update in an incident record.

### BRIEF DESCRIPTION OF DRAWINGS

FIG. 1A, FIG. 1B, and FIG. 1C show a procedural flowchart for different phases of natural disaster incident managements, in accordance with an embodiment of the invention.

FIG. 2A and FIG. 2B show an example of a “prime” database and an incident-specific database used in a system for multi-phase management of a natural disaster incident, in accordance with an embodiment of the invention.

FIG. 3A and FIG. 3B show an example of a pre-incident module and related structures and procedures for a system for multi-phase management of a natural disaster incident, in accordance with an embodiment of the invention.

FIG. 4A shows an example of a planning prioritization model for the pre-incident module and the related structures and procedures for a system for multi-phase management of a natural disaster incident, in accordance with an embodiment of the invention.

FIG. 4B shows another example of a planning prioritization model for the pre-incident module and the related structures and procedures for a system for multi-phase management of a natural disaster incident, in accordance with an embodiment of the invention.

FIG. 5A, FIG. 5B, FIG. 5C, and FIG. 5D show an example of a crisis response module and related structures and procedures for a system for multi-phase management of a natural disaster incident, in accordance with an embodiment of the invention.

FIG. 6A and FIG. 6B show an example of a rehabilitation management module and related structures and procedures for a system for multi-phase management of a natural disaster incident, in accordance with an embodiment of the invention.

FIG. 7A and FIG. 7B show an example of an update function and related procedures for a system for multi-phase management of a natural disaster incident, in accordance with an embodiment of the invention.

FIG. 8 shows a graph comparing the effectiveness of using an embodiment of the invention in a dotted line vs. a conventional disaster management method in a solid line.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of description of shapes, configurations, and/or other symbolic representations that directly or indirectly resemble one or more apparatuses and methods for a system for multi-phase management of a natural disaster incident. These process descriptions and representations are the means used by those experienced or skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specifications are not necessarily all referring to the same embodiment. Furthermore, separate or alternative embodiments are not necessarily mutually exclusive of other embodiments. Moreover, the order of blocks in process flowcharts or diagrams representing one or more embodiments of the invention does not inherently indicate any particular order and do not imply any limitations in the invention.

In general, embodiments of the invention relate to a systematic management of a natural disaster incident. In particular, the invention provides a system for multi-phase management of a natural disaster incident as a lifecycle, wherein the lifecycle can be perceived as a multi-phase systematic management starting from an incident prevention/preparation to a post-incident rehabilitation management after an outbreak of an incident. In a preferred embodiment of the invention, a natural disaster lifecycle management involves preemptive risk reduction management, crisis (i.e. incident-breakout) response management, and post-incident management via a computerized system with easy scalability and compatibility among different disaster management agencies (i.e. private, local, state, and federal).

For the purpose of describing the invention, a term “StatPlan®” is defined as an example of a novel IT solution implemented on a computer system in accordance with an embodiment of the present invention, wherein the novel IT solution accommodates multi-phase management of a natural disaster incident.

In addition, for the purpose of describing the invention, a term “tactical environment” is defined as features, strategies, resources, and/or conditions related to an operation environment as a crisis/natural disaster situation evolves, which requires an active involvement of a crisis/natural disaster response team for damage reduction and management of the crisis/natural disaster situation.

Moreover, for the purpose of describing the invention, a term “incident” is defined as an event related to a natural disaster situation, an environment-related emergency, or another emergency, which may require attention by a crisis response team.

The present invention discloses a technological tool designed to improve preparation for and response to natural disasters such as wildfire. In a preferred embodiment of the invention, this novel IT solution is branded as “StatPlan® Emergency Planning Support Package,” or “StatPlan®” in short as a registered trademark. One or more embodiments of the present invention contain highly specific database information, planning and crisis response procedures, and software routines that link information, enhance communications, and provide easy access. An IT solution as embodied by the present invention will support a crisis response team by efficiently providing an access to a system containing specific and detailed information relevant to the tactical environment of a natural disaster incident. In a preferred embodiment of the invention, the IT solution includes a database which enables a crisis response personnel to access frequently-updated information categorized by a type of an incident, a particular location of the incident, and a particular change in the tactical environment of the natural disaster incident.

In addition to the robustness of information contained in the database, the IT solution in the preferred embodiment of the invention incorporates the following characteristics and features to make this IT solution an essential tool both for emergency planning and response:
A vast database easily accessible through its information search and display features;
Options for customization functions based on client (e.g. emergency personnel needs;
Communication features tailored for use in wild land and/or other emergency response situations; and
Rapid update functions that provide the most current information as the emergency incident evolves.

Furthermore, embodiments of the present invention can be used in response to natural disasters by private entities, community groups, state, national, and international agencies to achieve one or more of the following potential objectives:
Prevent or reduce damage to or destruction of human and natural resources;
Protect the lives, health and safety of community members impacted by a natural disaster, and;
Protect the lives, health and safety of emergency/disaster response personnel.

In a preferred embodiment of the invention, natural disaster management has three distinct phases with each phase having different planning and implementation needs. The IT solution embodied by a preferred embodiment of the present invention incorporates at least the following three phases.
Pre-Incident Risk Reduction Management
Crisis Response Management
Restoration and Rehabilitation Management

Because the IT solution of the preferred embodiment of the present invention can provide current, comprehensive, robust, and accurate information throughout the multiple phases of the natural disaster management, a rapid database-update feature built into the IT solution of the preferred embodiment of the invention will allow emergency/disaster response team managers to prevent a likely loss of management control caused by overwhelming pace and number of changes in a rapidly-evolving tactical environment.

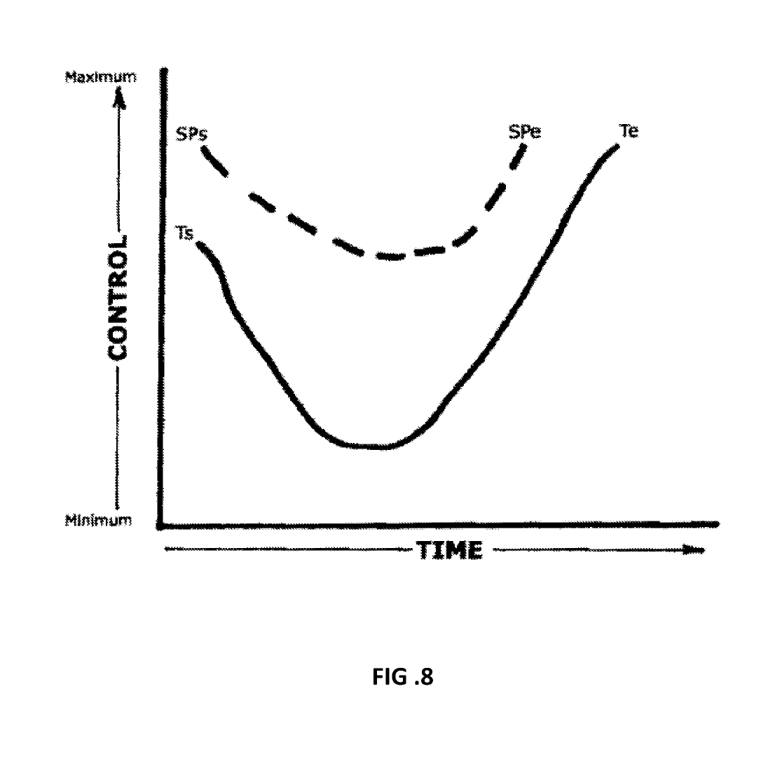

For example, FIG. 8 compares the predicted effectiveness of managing a response to an incident with and without the use of a preferred embodiment of the invention (e.g. StatPlan®) for pre-incident risk reduction and crisis response management. Each incident-response action has a starting point (e.g. Ts, SPs) and an end point (e.g. Te, SPe) which are plotted against the amount of control by managers. For FIG. 8, the solid line shows the level of managerial control for a particular disaster/crisis incident over a time frame covering a pre-incident planning and an incident management. The dotted line shows an expected increased level of managerial control for the same disaster/crisis incident over the same time frame for the same pre-incident planning and the incident management when the preferred embodiment of the invention (e.g. StatPlan®) is used.

Continuing with the example of FIG. 8, at the starting point (e.g. Ts, SPs) of the incident, managers in the incident control (IC) group have a certain level of control over the crisis response-related management strategy. The actual conditions of the tactical environment at the starting point may be a direct result of prior planning and management. An IT solution in the preferred embodiment of the invention (e.g. StatPlan®) has been developed as a resource to help managers achieve a higher initial level of management control (SPs). Access to greater amounts of specific and current tactical environmental data in databases provided by the IT solution of the preferred embodiment alone is likely to elevate the starting point (SPs). Furthermore, the pre-incident management in the IT solution (e.g. StatPlan®) of the preferred embodiment of the invention assists establishing tactical environmental conditions which enable increased control and improved opportunities for successful management in an event of a natural disaster incident.

In theory, management control levels drop dramatically during the incident as a result of an increased complexity of resource deployment and changes to the tactical environment caused by the incident itself. Eventually, though, as the combination of response management and natural forces take effect, managerial control levels improve (Te). Therefore, a novel IT solution implemented on a computer system as envisioned in the preferred embodiment of the invention can conceivably shorten an incident period, because the increased level of managerial control is likely to improve the effectiveness of resource deployment which induces a quicker recovery of absolute control at the end point (SPe) when the novel IT solution is used. Utilizing the preferred embodiment of the invention, the level of readiness and control for disaster/crisis response management can be much higher due to a systematic pre-incident planning. Moreover, a typical drop in the level of response team control during the incident is offset by robust update and access to an incident site provided by the novel IT solution. One or more embodiments of the present invention enable a high level of management control over a natural disaster incident compared to conventional methods of disaster/emergency response.

### Planning for Various Phases of a Natural Disaster Incident

A novel IT solution embodied by the present invention will support a disaster/emergency response team and its managers for risk-reduction, logistic preparation, and resource utilization planning stages by providing a coherent IT platform which manages at least three distinct phases of the natural disaster cycle. In a preferred embodiment of the invention, the first stage of the three phases is “Pre-Incident Risk Reduction Management,” wherein the objective of the first stage is minimizing the risk of incident occurrence or reducing the potential damages caused by an incident in case of an outbreak of the incident. In addition, the second stage of the three phases is “Crisis Response,” wherein the objective of the second stage is saving lives, preserving health of residents and emergency response personnel, and protecting property in a crisis area. Furthermore, the third stage of the three phases is “Recovery and Rehabilitation Management,” wherein the objective of the third stage is restoring the crisis area to its pre-incident condition if possible and making improvements based on the assessment of the changes to the crisis area as a result of the incident.

In one or more embodiments of the invention, outcomes due to some actions taken in each of the three phases may have similar effects in natural disaster managements. Nevertheless, each phase typically involves different timelines, information, procedural needs, personnel, and/or levels of risk. Table 1 below shows a comparative example of principal elements of these three phases.

TABLE 1

| | | | Recovery/ |
|---|---|---|---|
| | Pre-Incident | Crisis Response | Rehabilitation |
| | Phase | Phase | Phase |
| Planning | Weeks to Months | Minutes to Hours | Weeks to Years |
| Horizon | | | |
| Planning Level | Predominantly | Predominantly | Predominantly |
| | Strategic | Tactical | Strategic |
| Staffing | Local | Non-Local | Non-local |
| | | | and Local |
| Site Familiarity | High | Extremely Low | Mixed |
| Resources | Pre-planned, | Reactionary, | Pre-planned, |
| Deployment | single | multiple | single |
| Risk | None | Extreme | None |
| Results | Long-term | Short-term | Short-to-medium |

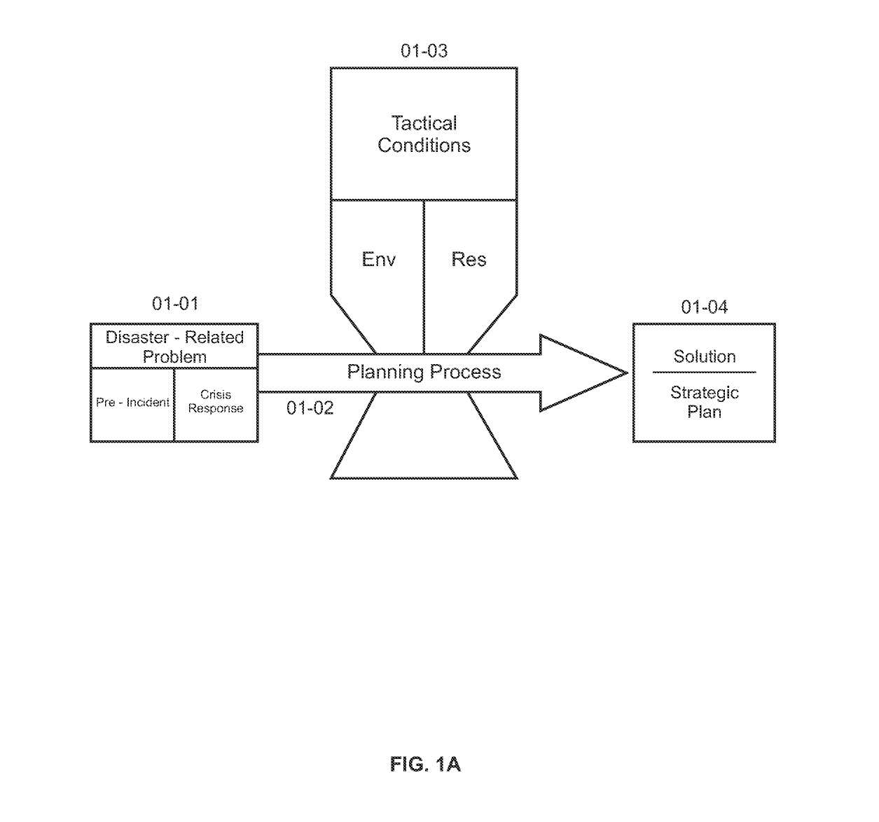

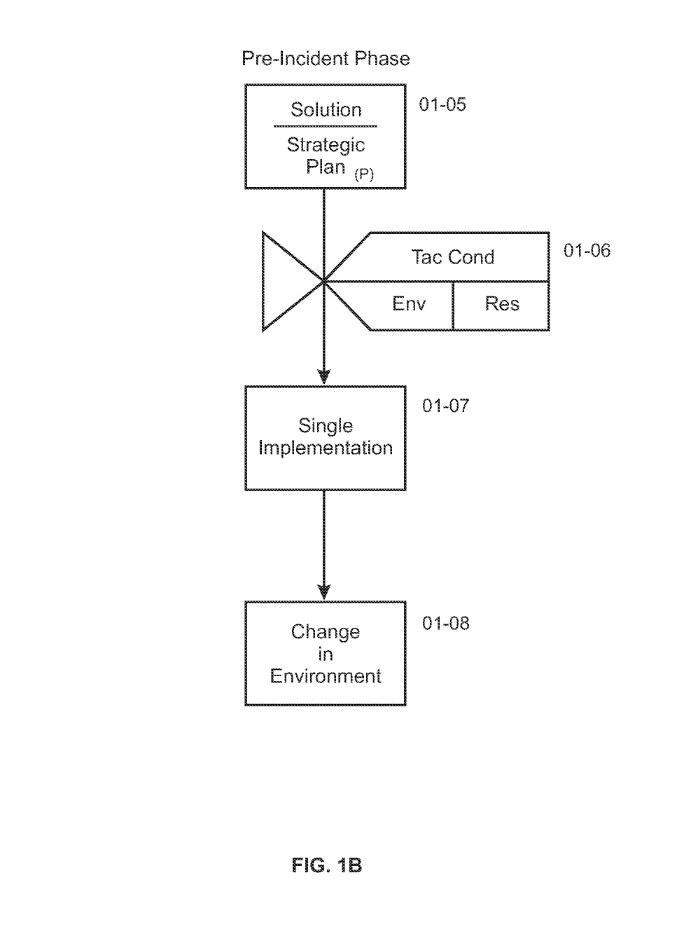

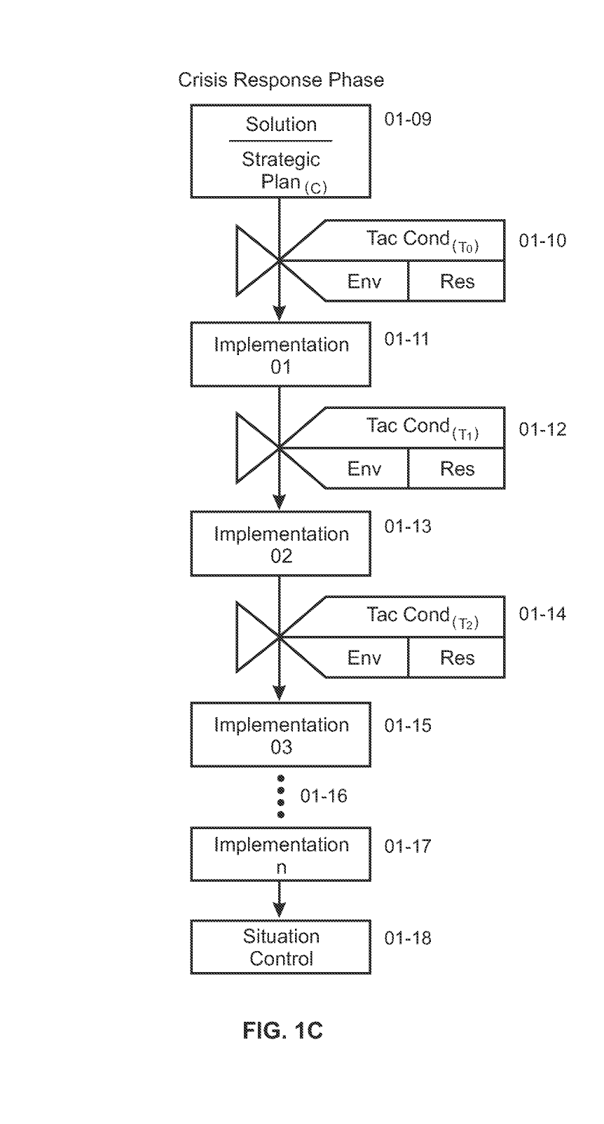

Furthermore, at least some of these differences are shown graphically in a flowchart of FIG. 1A˜FIG. 1C. FIG. 1A˜FIG. 1C show the flowchart for different phases of natural disaster incident managements, in accordance with an embodiment of the invention. In a preferred embodiment of the invention, the three phases require some common actions at the beginning of each phase. In the preferred embodiment of the invention, when a manager needs to respond to a problem, the manager's first action is to implement a planning process in order to identify a strategy. Once the strategy is devised after the planning process, the manager can prepare an associated plan which will lead to the solution of the problem after the associated plan is implemented. In one embodiment of the invention, a first step (01-01) is defining the problem either for a pre-incident risk reduction management phase or a crisis response phase. In the pre-incident risk reduction management phase, the manager has the relative luxury of spending time with the first step (01-01). In contrast, the manger responding to an incident during the crisis response phase has little control over time, because an outbreak of the incident substantially defines the problem in the first place. In the recovery/rehabilitation phase, the amount of time available for the first step (01-01) can vary considerably based on the specificity of the incident and subsequently-required actions.

In the preferred embodiment of the invention, the second step is getting involved in devising a plan in a planning process (01-02). Then, as shown in a process block (01-03), a key element of consideration for the manger in all phases is an understanding of tactical environment and conditions for effective resource deployment. The result of completing these procedures (01-01, 01-02, and 01-03) is a proposed solution or a strategic plan (01-04), which generally contains strategic and tactical elements.

The common elements of planning for the three phases, as exhibited in the first four procedures (01-01, 01-02, 01-03, and 01-04), begin to depart in subsequent steps due to different procedural and information needs. In response to these different functional needs, the preferred embodiment (e.g. StatPlan®) of the present invention incorporates three distinct modules for the three phases, each module of which incorporates and reflects particularities of each phase. The details of these three modules are discussed in subsequent figures.

Continuing with FIG. 1A˜FIG. 1C, in the Pre-Incident Risk Reduction Management Phase, a proposed solution or a strategic plan (01-05) (i.e. which may be similar or identical to the proposed solution or the strategic plan (01-04) of FIG. 1A) is typically implemented as a continuous series of closely-related actions over a fairly short period of time. The plan is typically prepared and implemented by professionals with good knowledge of a relevant area for the pre-incident management. The actions taken during the Pre-Incident Risk Reduction Management Phase are usually determined primarily by the resources available (e.g. budget, time, equipment, etc.) and also secondarily influenced by current conditions of the tactical environment, as shown in a subsequent process block (01-06). In addition, only a minimal amount of risk for human lives and resources are involved with the implementation (01-07) of the plan in the Pre-Incident Risk Reduction Management Phase. The implementation (01-07) of the plan results in a change in tactical conditions of the relevant area for the pre-incident management, as shown in a process block (01-08). This change at the Pre-Incident Risk Reduction Management Phase may reduce potential risks associated with a future natural disaster incident.

In the Crisis Response Phase, planning and implementation needs are significantly different from the Pre-Incident Risk Reduction Management Phase. A typical characteristic of this phase is rapid change. Rapid changes in the tactical environment, available resources, and emergency response personnel commonly occur in this phase. A first distinct step in the Crisis Response Phase is assessing a current capacity (01-09) to implement the prepared strategic plan in context of the tactical environment (01-10). Based on the results of the assessment, the strategic plan is implemented through an initial deployment of resources (01-11). Then, as changes occur in either the tactical environment or the availability of resources (01-12), the strategic plan can be revised to impact new deployments or re-deployment (01-13) of resources. This iterative process can be repeated (01-14, 01-15 to 01-17) until the objective of the overall strategic plan is satisfied, resulting in a situation control (01-18). In general, the situation control (01-18) is possible after effective resource deployments by the final deployment (i.e. plan implementation) step (01-17) for the Crisis Response Phase. The preferred embodiment (e.g. StatPlan®) of the novel IT solution implemented in a computerized system is uniquely designed and constructed to support rapid and iterative decision-making for the Crisis Response Phase under emergency conditions.

The Recovery and Rehabilitation Phase follows a similar procedural pathway as the Pre-Incident Risk Reduction Management Phase but relies on consideration of a different set of tactical environmental conditions to formulate a plan. For example, instead of using information contained within an existing database (01-03), the existing database is updated with new information collected in the field during a recovery and rehabilitation field trip by investigators or response personnel. Then, the updated database can be used to formulate the plan.

### Embodiment of the Invention Common to Different Phases of Planning

Embodiments of the present invention make comprehensive information related to the tactical environment available. The information related to the tactical environment includes, but is not limited to, an area of interest to a user and other information essential in both pre-incident and incident response situations. A database covering the user's area of interest and other information meeting the user's specific needs is a helpful common element to different phases of planning.

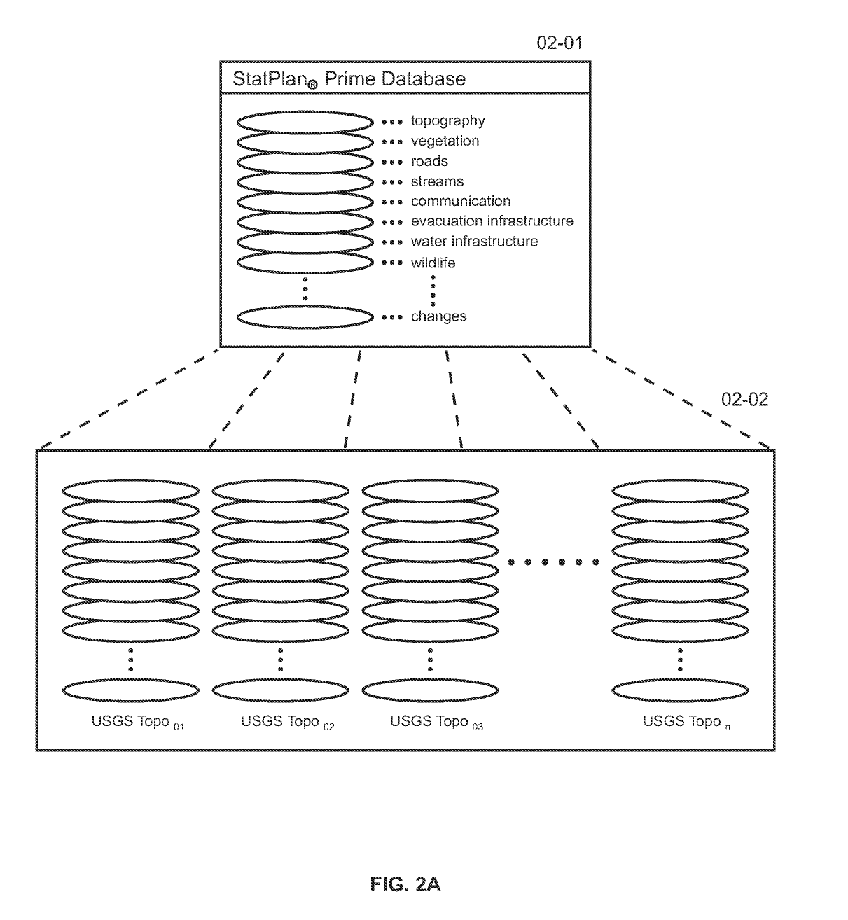

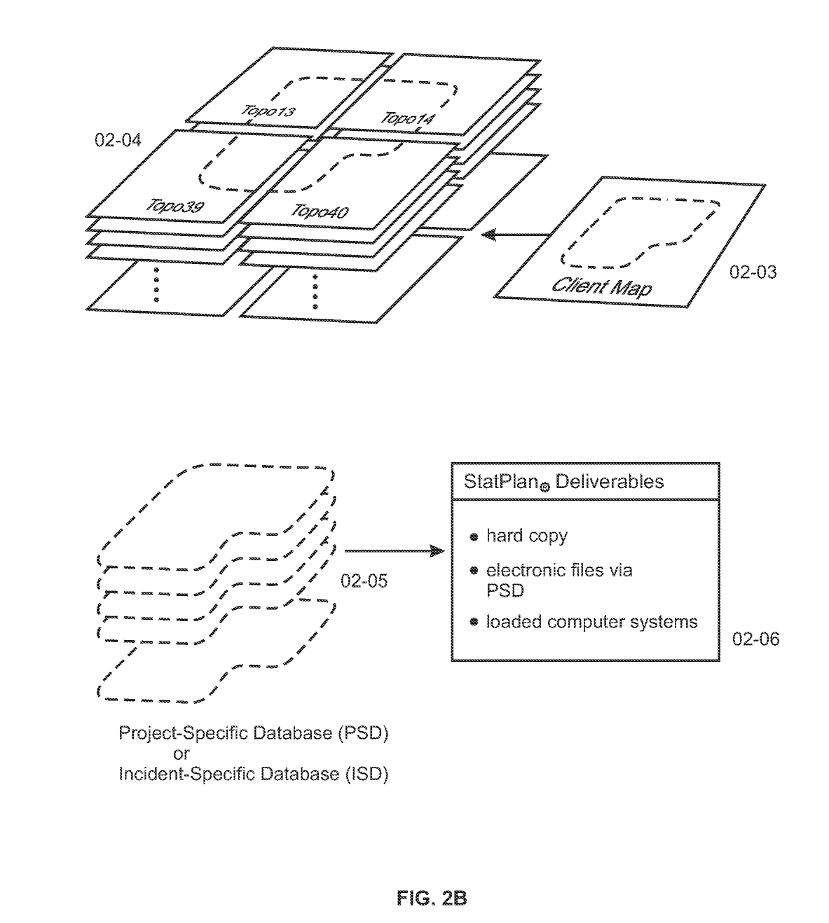

FIG. 2A˜FIG. 2B show an example of a “prime” database used in a system for multi-phase management of a natural disaster incident, in accordance with an embodiment of the invention. In a preferred embodiment of the invention, the database is usually a subset of one that covers a much larger area. Subsets of databases are derived from a more extensive database, which is defined herein as the “prime” database (02-01).

In a preferred embodiment of the invention, the architecture of the prime database is a typical architecture used for GIS (i.e. graphical interface system) analysis: a bundle of geo-referenced layers, with each layer storing information for a single theme relevant to analysis associated with emergency management and response. The prime database includes, but is not limited to, the following themes, along with some more specific attributes:
Land jurisdiction pattern
Road information
   Location
   Physical specifications
Vegetation formations
   Type description
   Formation boundaries
   Discrete formation surface area
Water infrastructure
   Natural drainage system specifications
   Potable water sources
   Potable water delivery systems
Wildlife and Habitat
   Listed species presence and locations
   Critical habitat locations
   Environmentally sensitive habitat locations
Geologic or Soils Hazards
   Location of unstable areas
Waste disposal infrastructure
   Sanitary
   Solid
Energy infrastructure
   Electricity
   Natural gas
   Petrochemicals
Communications infrastructure
   Linear structures
   Discrete sites
Commercial infrastructure
   Lodging
   Food service
   Fuels services
   Building materials and services
   Equipment services
   Education/conference facilities
Cultural resources
   Historic sites
   Landmarks
   Recreational facilities
   Parks and reserves
Emergency response infrastructure
   Ground evacuation routes
   Aerial access (in/out)
   Marine access (in/out)
Emergency services infrastructure
   Law enforcement
   Fire response
   Medical response
   Infrastructure repair
   Emergency lodging

A business entity operating an embodiment of the present invention can store the prime database in a secure location. The prime database can be robustly maintained by adding newly-covered areas and relevant information to the prime database and updating other pertinent information. In one embodiment of the invention, the basic unit of area coverage used in the prime database is a standardized 1/24,000 scale United State Geological Survey (USGS) topographic map data objects (02-02), which serves as standardized data sets retrieved from a computer system.

In a preferred embodiment of the invention, a user-defined database which may be based on a subset of the prime database is prepared per client specifications by a novel system embodied by the present invention. In pre-incident applications, a first subset of the prime database is defined as the “Project-Specific Database (PSD).” In crisis response applications, a second subset of the prime database is defined as the “Incident-Specific Database (ISD).” These subsets of the prime database may be entirely based on the prime database, or only partially based on the prime database. In a preferred embodiment of the invention, a user or another entity associated with the PSD or the ISD can provide particular geographical or resource-related information from a client perspective (e.g. “Client Map”) (02-03), which can be merged, superimposed, and/or synthesized with a standard USGS map base. The standard USGS map base may be derived from the prime database alone or from a plurality of geographic data sources.

In the preferred embodiment of the invention, a user of the computerized system for multi-phase management of a natural disaster incident can select geographical and resource-related file bundles (e.g. one or more geo-reference layers) corresponding to the USGS quadrangles that cover the indicated project area (02-04). Using standard “clipping” and “stitching” techniques, a geo-reference layer package constituting a user-defined, project-specific, and/or incident-specific database (e.g. PSD, ISD) is created for the indicated project area (02-05). In case of pre-incident applications, this PSD may contain the same data-layer set as the prime Database, but only for the area of the specified project.

Continuing with FIG. 2A˜FIG. 2B, in one embodiment of the invention, the user-defined, project-specific, and/or incident-specific database is delivered to a client (e.g. a user of the computerized system) using a portable storage device or a computer system pre-loaded with the multi-phase management program for the natural disaster incident (02-06). In the preferred embodiment of the invention, an operating software per license or individual user agreement for the multi-phase management program for the natural disaster incident (02-06) is appropriately negotiated and enforced between a service provider for the multi-phase management program (e.g. a software/system developer) and a client entity (e.g. a municipal, state, or federal natural disaster response agency).

Furthermore, a computerized system for multi-phase management of a natural disaster incident as embodied by the invention can also deliver a hard copy version available in the computerized system, wherein the hard copy version is suitably formatted and produced for emergency conditions in a rugged environment. An example of this type of product would be a hard copy of a “StatPlan® Road Atlas” for a user-defined project or incident area, wherein the StatPlan® Road Atlas document is durably bound and printed on water-repellent and rip-resistant materials. In one embodiment of the invention, the StatPlan® Road Atlas contains all information associated with a lookup-table or another data structure for a road layer in a user-defined project or an incident area. Even though the hard copy of the Road Atlas may not be immediately updatable, these materials have high utility in the field under difficult conditions and provide valuable information if a user cannot access a computer or loses computerized data communications with an incident command (IC) group.

### System Applications

A computerized system for multi-phase management of a natural disaster incident as embodied by the invention has been developed for several applications, including two related phases of emergency response: Pre-incident Risk Reduction Management Phase and Crisis Response Management Phase. Based on client requirements, a computerized system for multi-phase management of a natural disaster incident as embodied by the invention can provide a package specific to requirements in each phase. Following are descriptions of the unique processes and products enabling the IT solution.

### Pre-Incident/Pre-Emptive Management Support

Pre-incident/pre-emptive management portion of an embodiment of the invention focuses on maximizing the efficiency of the use of available resources for accomplishing an incident command's (IC's) or a management's goals and objectives during a non-emergency timeframe in which the time sensitivity to a potentially-dangerous and/or evolving tactical environment is not an issue.

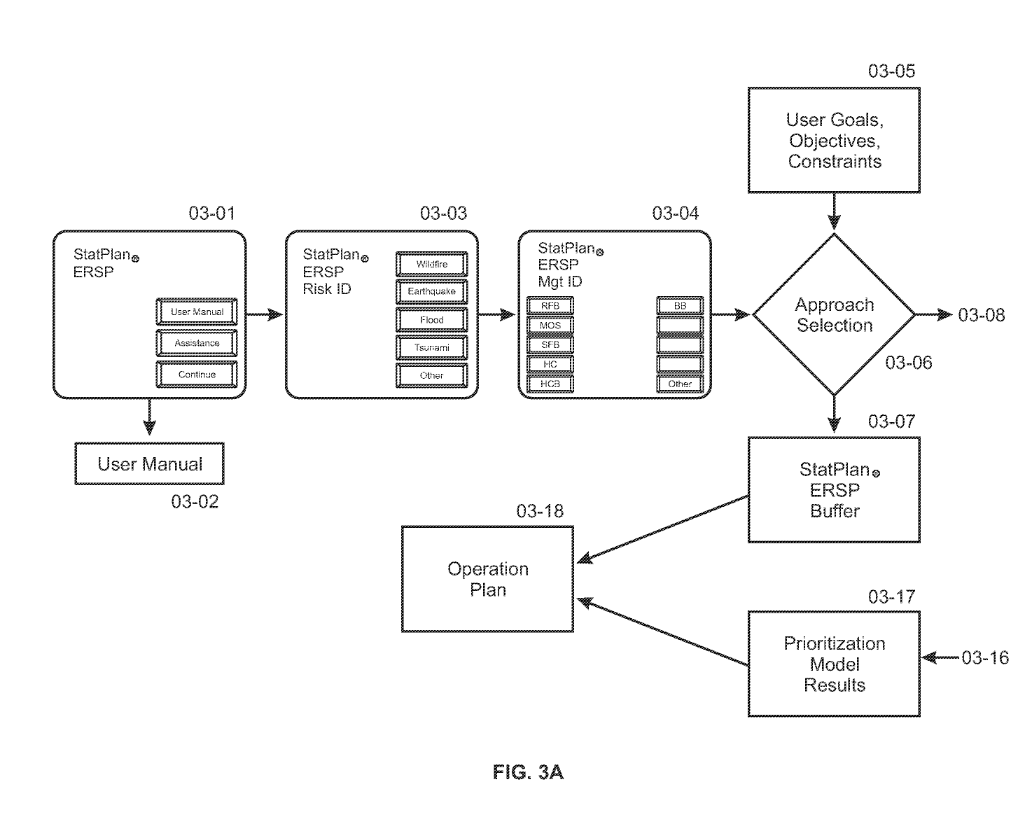

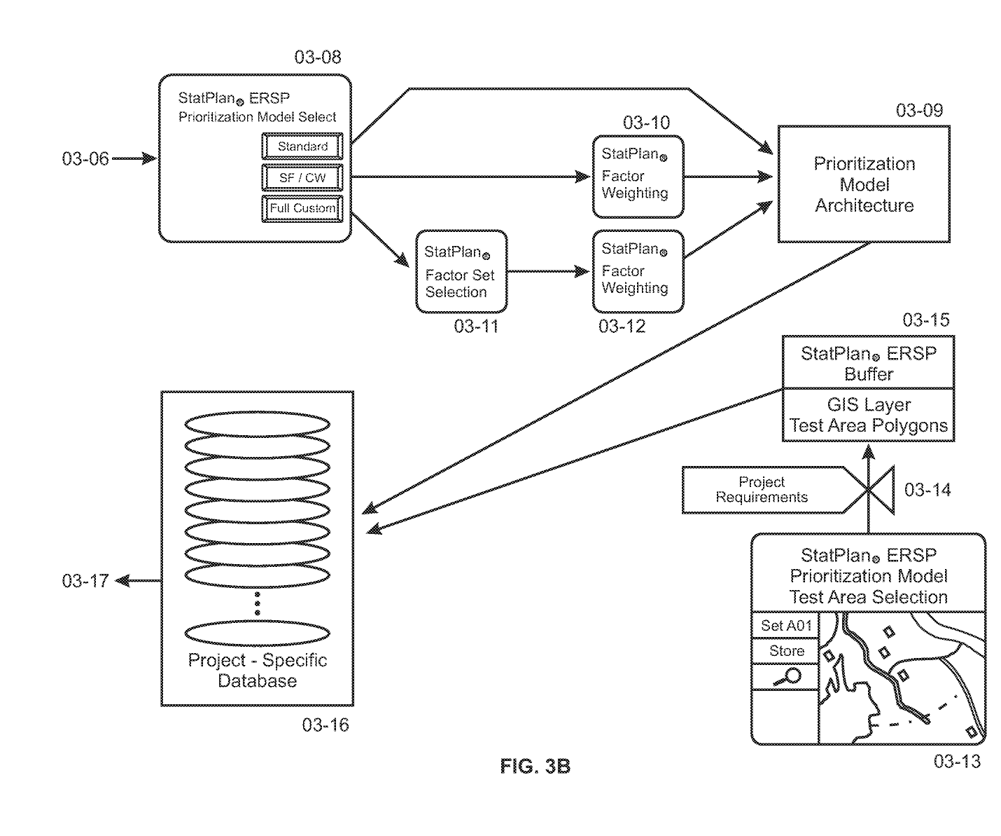

FIG. 3A˜FIG. 3B show an example of a pre-incident module and related structures and procedures for a system for multi-phase management of a natural disaster incident, in accordance with an embodiment of the invention. In a preferred embodiment of the invention, a pre-incident user interface (03-01) is operatively connected to a pre-incident module operating program and any relevant databases such as the PSD, the ISD, and the prime database. The pre-incident module operating program provides and manages any data inputs, storage, and outputs from the pre-incident module.

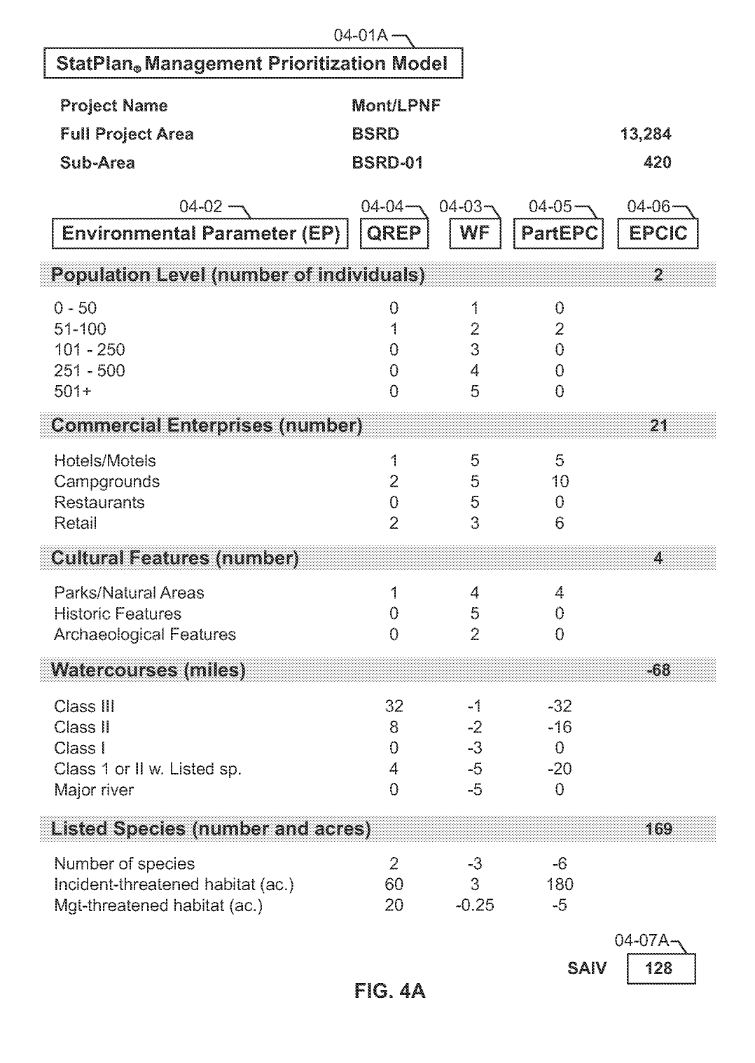

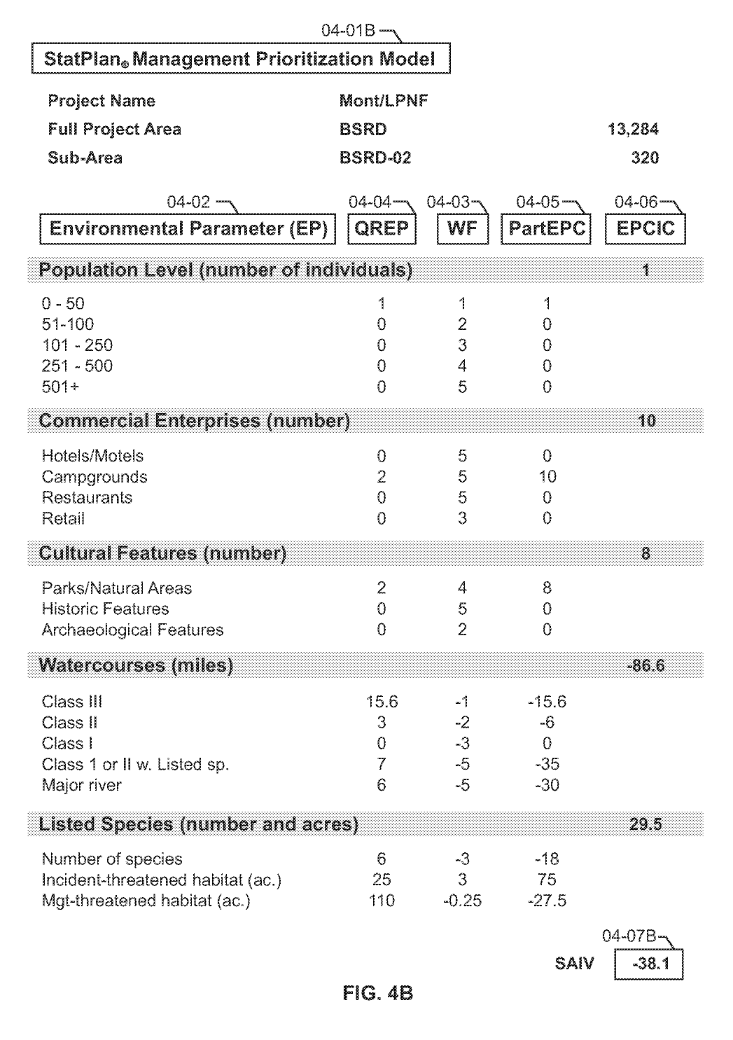

As shown in FIG. 4A and FIG. 4B, in the preferred embodiment of the invention, the pre-incident module is also operatively connected to a prioritization model user interface (04-01A, 04-01B) and a prioritization model program, wherein the prioritization model program can derive a sub-area index value (SAIV) (04-07A, 04-07B). The SAIV, which is unique to the invention, is a directly-comparable quantitative measure of priority for pre-incident planning among different resources or regions. This quantitative measure is derived by analyzing an environmental parameter (EP) (04-02), a weighting factor parameter (04-03), and a quantitative representation of the environmental parameter (QREP) (04-04) for a specific area from the PSD, as shown in FIG. 4A and FIG. 4B.

In one embodiment of the invention, a pre-incident user interface (03-01) is called an “opening panel” for the pre-incident module. The opening panel can provide a brief description of the available program functions and program version information to a user. The opening panel can also contain links to other sectors including a ReadMe file associated with a user manual (03-02) for the pre-incident module, a service contact information for personalized assistance, and the pre-incident module operating program. In one example, selecting a “Continue Program” link or button engages the pre-incident module operating program to produce a user interface screen which allows the user to initiate an analysis of resources categorized by risk types, or “risk ID's” (03-03). Another user interface screen (03-04) can enable the user to interact with a comprehensive set of industry standard management actions which can be employed to mitigate for a particular risk ID selected in the previous user interface screen (03-03).

In a preferred embodiment of the invention, the comprehensive set of industry standard management actions are fully researched, continually updated, and commercially offered by a computerized system for multi-phase management of a natural disaster incident as embodied by the invention. In one example, an individual user can select a desirable management action (03-06) which suits the need of an incident command (IC) or a particular manager. The IC or the particular manager can take a subjective decision framework (goals, particular management objectives, constraints, etc. (03-05)) into account when the desirable management action is selected. The selected management action along with its set of operational attributes (e.g. equipment requirements, unit costs, etc.) are then stored in a temporary buffer, a storage medium, and/or a memory unit (e.g. 03-07) for subsequent use in the analysis process.

FIG. 4A and FIG. 4B show an example of a planning prioritization model for the pre-incident module and the related structures and procedures for a system for multi-phase management of a natural disaster incident, in accordance with an embodiment of the invention. After storing the selected management action along with its set of operational attributes, as shown in a buffer (03-07) of FIG. 3A, the next step is to execute the prioritization model program. In a preferred embodiment of the invention, this prioritization model program is a simulation program unique to the invention and employs a matrix approach (04-01A, 04-01B) with a list of environmental parameters (EP's) (04-02), a list of weighting factor parameters (04-03), a list of quantitative representation of the environmental parameters (QREP's) (04-04), and a list of partial environmental parameter coefficients (Part EPC) (04-05).

In particular, FIG. 4A shows a screenshot of a first sub-area, “BSRD-01,” from an example of a planning prioritization model (i.e. StatPlan® Management Prioritization Model, which is a name of a commercial product based on a preferred embodiment of the invention). In addition, FIG. 4B shows a screenshot of a second sub-area, “BSRD-02,” from the same example of the planning prioritization model of FIG. 4A in accordance with the preferred embodiment of the invention.

In one embodiment of the invention as shown in FIG. 4A and FIG. 4B, the environmental parameters (EP's) (04-02) define any geographic points of interests, man-made structures, and/or non-physical (i.e. intangible) environmental parameters (EP's) such as population and commercial usage of a particular region, as illustrated by the list of environmental parameters (EP's) (04-02). In addition, the weighting factor parameters (04-03) can generally indicate a subjective quantitative measure for importance or urgency of a pre-incident planning for a particular resource. This prioritization parameter (i.e. the weighting factor parameters (04-03)) for pre-incident planning is generally a subjective number based on an empirical or experiential sense of urgency for a pre-incident planning for a particular resource. For example, a commercial region listed as an environmental parameter (EP) may have a higher priority for pre-incident planning than a nearby pond because more human lives may be potentially under risk in the commercial region than the nearby pond. In this example, the commercial region is assigned a weighting factor of 5.0, while the pond is given a weighting factor of 2.5.

Furthermore, the quantitative representation of the environmental parameters (QREP's) (04-04) can incorporate a quantitative feature for a particular resource from the PSD. For example, the commercial region from the example above may have a certain PSD result value based on the size of the commercial region. If the commercial region is substantially large, a high PSD result value can be assigned, whereas a smaller commercial region results in an assignment of a low PSD result value. Similarly, a large pond can have a high PSD result value than a smaller pond. In addition, a partial environmental parameter coefficient, or Part EPC (04-05) is a parameter which can optionally incorporate a client's subjective priority factor for a particular resource from the environmental parameter (EP) (04-02). In a preferred embodiment of the invention, the weighting factor (WF) (04-03) may be provided by a service provider or a program developer based on general statistical priorities for environmental parameters (EP's), whereas the Part EPC (04-05) may be provided by a client entity or an incident command (IC) based on its client-specific situations. In an alternative embodiment of the invention, the weighting factor (04-03) may also be customized by the client entity.

Continuing with FIG. 4A and FIG. 4B, in one embodiment of the invention, the planning prioritization model allows users to conduct a comparative analysis among multiple locations to identify high-priority (i.e. urgent) locations for preemptive and pre-incident management. As described previously, in a preferred embodiment of the invention, the planning prioritization model incorporates three elements: environmental parameters (EP's) (04-02), weighting factor parameters (04-03), and quantitative representation of the environmental parameters (QREP's) (04-04) for each resource as determined by an analysis from one or more geo-referenced layers. In one embodiment of the invention, the planning prioritization model tests for sensitivities associated with each environmental condition included in an input list (e.g. physical, biotic, cultural, construction types, and etc.). Environmental conditions related to various aspects of fire behavior, asset risk level, asset protection requirements, pre-incident management considerations, and incident response considerations are typically relevant to these tests or analysis.

In a base planning prioritization model, in one embodiment of the invention, each environmental condition is assigned an initial weighting factor (04-03) which incorporates subjective value for pre-incident planning prioritization as described previously. The quantitative representation of the environmental parameters (QREP's) (04-04) can be derived from querying a project-specific database (PSD). In one example, a sector of a typically geo-referenced data layer for the environmental condition corresponding to a subject polygon is queried, and the results are entered into the base planning prioritization model, which may analyze relevant information with respect to absolute presence or user-desired quantitative attributes (e.g. a length of road, an acreage of certain vegetation types, and etc.). A prioritization model program can compute a sub-area index value (SAIV) (04-07A, 04-07B) based on various parameters (04-02˜04-05) in FIG. 4A and FIG. 4B.

In a preferred embodiment of the invention, an environmental parameter contribution index coefficient (04-06) (EPCIC) is calculated by adding Part EPC values (04-05) from each sub-category for a particular environmental parameter (04-02) (EP) category such as Population Level, Commercial Enterprises, Cultural Features, Watercourses, and Listed Species, as shown in FIG. 4A and FIG. 4B. An SAIV (e.g. 04-07A, 04-07B) can be calculated by adding EPCIC values, as shown in FIG. 4A and FIG. 4B As mentioned previously, the SAIV, which is unique to the invention, is a directly-comparable quantitative measure of priority for pre-incident planning among different resources or regions. For example, if a first region has a higher SAIV than a second region, then the first region may be considered more important or “higher priority” than the second region for pre-incident planning.

The prioritization model approach for the pre-incident module as disclosed in FIG. 4A and FIG. 4B provides a quantitatively comparable method for determining disaster risk reduction management priorities when a large area is being considered and management resources are limited. In a preferred embodiment of the invention, one or more sub-areas are identified within a perimeter of a relevant disaster risk reduction management area, wherein one or more boundaries are determined by project-specific or area-specific needs. Subsequently, a comparative analysis is conducted using analysis criteria for categories or sub-categories for each environmental parameter (EP) (04-02). In one example of a prioritization model in accordance with an embodiment of the invention, the comparative analysis is accomplished through the use of a simulation model based on multi-variable mathematical equations that represent the relationships between the presence of physical, biological and cultural environment elements (e.g. environmental parameters (EP's)) and the need for implementing the risk reduction management. The principal result derived is a ranked list of quantitatively-comparable values, called the SAIV's.

### An Example of Prioritization Model Architecture and Components

The prioritization model as shown in FIG. 4A and FIG. 4B produces SAIV's using several input components and mathematical equations using defined parameters. How these components function in the analysis are described in greater detail below. A hypothetical example of the model and its components are shown at the right for the purposes of clarifying the following descriptions.

### An Example of Environmental Parameters (EP)

In the example shown in FIG. 4A and FIG. 4B, each EP (04-02) comprises a principal category and typically more detailed sub-categories called “partial environmental parameters” (Part EP's). FIG. 4A and FIG. 4B show that the “Commercial Enterprises” category is represented by four sub-categories: Hotels/Motels, Campgrounds, Restaurants, and Retail. Information regarding each of these sub-categories may be contained in one or more individual databases or GIS layers.

### An Example of Quantitative Representations of the Environmental Parameters (QREP)

In the example shown in FIG. 4A and FIG. 4B, the first of the primary input components is a quantitative representation (QREP) (04-04) of each of the Part EP's present in each sub-area (e.g. BSRD-01, BSRD-02). In this particular example, there are five different Part EP's in the full “Watercourses” category. The program can search a GIS data layer containing watercourse information for the area contained within sub-area BSRD-01 and loads the relevant information for each of the five Part EP's. This “data mining” operation can be completed for all of the EP and/or Part EP's in a particular sub-area. The set of EP's can vary depending on a type of a management action.

### An Example of Weighting Factors (WF)

In the example shown in FIG. 4A and FIG. 4B, the second input components are the weighting factors (WF) (04-03). WF's are paired with each of the EP's, or Part EP's to indicate the magnitude of influence each EP or Part EP in determining the value of a SAIV (e.g. 04-07A, 04-07B) for a particular sub-area (e.g. BSRD-01, BSRD-02).

Currently, WF's for SAIV calculations have not been standardized for a natural disaster management prioritization model. Therefore, WF's are determined through a process involving professional experience and judgment. An estimation of significance for each EP for risk reduction management determines a particular WF for prioritization of pre-incident planning. In one embodiment of the invention, it may be easier to assign weighting factors (WF's) among Part EP's within an EP category, but more difficult to do among the EP categories themselves. For example, it may be intuitive that higher-population locations should require more weighting for prioritization of pre-incident planning. Thus, in the example of FIG. 4A and FIG. 4B, “0-50” Part EP for “Population Level” category carries a less WF (i.e. “1”) than a WF (i.e. “5”) for “501+” Part EP for the same category. Assignment of particular WF values to Part EP's or EP's is generally subjective determined by experience or a management's particular emphasis.

Setting weighting factors (WF) among major environmental parameter (EP) categories may be even more subjective than setting weighting factors (WF) among partial environmental parameters (Part EP's). The subjective determination of WF's may be based on experience and know-how of disaster management operation and sensitivity analysis of prioritization models.

It is important to note that some environmental elements in one sub-area can be a positive element for a first pre-incident risk management activity for natural disasters, while those same environmental elements can have adverse effects in a second pre-incident risk management activity in another sub-area. Therefore, some risk reduction management practices may also adversely impact some elements of the environment. In terms of WF values, this may be indicated by positive or negative numbers. “Listed Species” EP category in FIG. 4A and FIG. 4B have three Part EP's (i.e. “Number of species,” “Incident-threatened habitat,” and “Mgt-threatened habitat”), which are assigned positive or negative numbers for WF's.

For example, natural disasters have direct adverse impacts on plant and wildlife species and their supporting habitat. In general, reducing the risk of such a disaster by implementing preventative risk-reduction measures should have a positive influence on the decision. A positive weighting factor (WF) of 3 associated with “Incident-threatened habitat” Part EP indicates a magnitude of this positive influence. However, some preventative risk-reduction measures can involve projects which adversely impact the environment, such as altering vegetation formations and changing surface soils. These actions can have adverse direct or indirect impacts on certain plant or animal species. In the example of FIG. 4A and FIG. 4B, the adverse effect of taking preventive measures on certain Part EP's (e.g. listed species) are demonstrated by negative-number WF's. For example, two other Part EP's under the “Listed Species” category in FIG. 4A and FIG. 4B carry negative weighting factors for “Number of species” and “Mgt-threatened habitat”. The presence of a high number of listed species and/or large acreages of habitat which are likely to be negatively impacted by a preventative risk-reduction measure may therefore reduce the appeal for an actual implementation of that preventive risk-reduction measure for that particular sub-area.

In one embodiment of the invention, a weighting factor (WF) that has a positive value gets added to an aggregate of environmental parameter contribution index coefficient (EPCIC) for a final value of a SAIV, whereas a weighting factor (WF) that has a negative value gets subtracted from the aggregate of EPCIC for the final value of the SAIV.

### An Example of a Mathematical Computations and the Resulting Sub-Area Index Value (SAIV)

For a prioritization model as illustrated by FIG. 4A and FIG. 4B, the end product of the analysis involving QREP, WF, Part EPC, and EPCIC is a quantitatively comparable index among many different sub-areas. This index is also called a sub-area Index Value (SAIV). The SAIV can be calculated in multiple steps. For example, EP categories may only require two-step procedures, whereas PartialEP categories may require three-step procedures. Equation below is the basic two-variable expression used to calculate an EP's contribution to the SAIV. The two input variables are: 1) the QREP and 2) the WF. The quantitative result for a particular environmental parameter is multiplied by its corresponding weighting factor to produce an environmental parameter contribution index coefficient (EPCIC).

The equation for each individual environmental parameter's contribution (EPCIC) takes the following form:

EPCIC_{EP}=QREP_{EP}×WF_{EP} (Equation 1)

Once all of the individual EP calculations have been run the equation for calculating the sub-area Index Value (SAIV) in the two-step process takes the form:

SAIV_{SAx}=EPCIC_{EP1}+EPCIC_{EP2}+EPCIC_{EP3}+ . . . +EPCIC_{EPn} (Equation 2)

In a case where the main EP category is represented by more than one partial environmental parameter (PartEP), the three equations are:

PartEPC_{PartEP}=QREP_{PartEP}×WF_{PartEP} (Equation 3)

EPCIC_{EP}=PartEPC_{PartEP1}+PartEPC_{PartEPC2}+ . . . +PartEPC_{PartEPCn} (Equation 4)

SAIV_{SAx}=EPCIC_{EP1}+EPCIC_{EP2}+EPCIC_{EP3}+ . . . +EPCIC_{EPn} (Equation 5)

In one embodiment of the invention, after all the sub-area analysis have been completed the SAIV's are presented in a ranked list to a user. sub-areas with higher SAIV's have higher priorities for pre-incident planning than sub-areas with lower SAIV's. In general, the sub-area with the highest SAIV is identified as the most urgent region for implementing the proposed management.

### A Simplified Example of SAIV Calculation

A very simplified example is presented in relation to FIG. 4A and FIG. 4B. This is a comparative example for two sub-areas (i.e. BSRD-01 of FIG. 4A, BSRD-02 of FIG. 4B) within a project area. In this particular example, the EP list is made up of 20 separate partial EP's (Part EP's) representing five EP (04-02) categories: Population Level, Commercial Enterprises, Cultural Features, Watercourses, and Listed Species. Each sub-area analyzed within a full project area may have identical list of EP's and Part EP's. These elements are shown in the far left-hand column in FIG. 4A and FIG. 4B. The second column (04-04), titled “QREP,” is the quantitative representation of a particular Part EP as determined by a database or GIS layer associated with StatPlan®. The third column shows the weighting factors (WF's) (04-03), and the fourth column is the partial environment parameter coefficient (Part EPC) (04-05). The fifth column is an environmental parameter contribution index coefficient (EPCIC) (04-06).

The SAIV (04-07A) for sub-area “BSRD-01” is 128 for FIG. 4A, and the SAIV (04-07B) for sub-area “BSRD-02” is −38.1 for FIG. 4B. The higher SAIV score for the sub-area “BSRD-01” is due to a higher level of population, commercial establishments, and cultural features, which are high priority consideration for protection from natural disasters. Furthermore, both sub-areas have approximately the same internal result for watercourses, but a significant difference in “Listed Species” EP category calculations favored the sub-area “BSRD-01” of FIG. 4A as a higher priority region for pre-incident planning over the sub-area “BSRD-02” of FIG. 4B.

As shown in FIG. 3B, in one embodiment of the invention, a prioritization model function is initiated in a user interface (03-08) which allows the user to select one of three options (i.e. “standard”, “SF/CW”, “Full Custom” from the user interface (03-08)) regarding the prioritization model architecture (03-09): standard model (“standard” button, standard environmental condition set with user set weighting factors (“SF/CW” button), or a completely custom set (“Full Custom” button) of environmental conditions and weighting factors. Selecting the standard model uses prioritization model categories and weighting values that are pre-set into the computerized system, which stores this standard model's architecture into a buffer space, a storage unit, or a memory unit.

On the other hand, if the user wants to use the standard set of environmental conditions in the model, but wants to create custom weighting factors, the second option is selected. A user interface for the second option can take the user through a standard set of factors, which allows the user to pick and choose from the standard set of factors (03-10). Upon completion of a process of defining the desired weighting factors, the specified architecture (03-09) is stored into the buffer space.

Alternatively, if the user wants to utilize a completely customized set of environmental conditions and weighting factors, the third option is selected. A user interface for the third option can take the user through a customized set of environmental conditions from a full standard set (03-11). The user can define, select, and customize relevant environmental conditions in order to customize the configuration of the weighting factors (03-12). Upon completion of the selection process, this version of the model (03-09) is stored in the buffer.

In a preferred embodiment of the invention, the next sector of the prioritization model program enables the selection of various geographic areas which are the subject of the comparative pre-incident planning priority (alternatively called “prioritization”) analysis. From a standard geo-referenced database (e.g. USGS topographic maps or aerial images (03-13)) provided as part of the computerized system for the multi-phase management of a natural disaster incident, the user is allowed to create as many individual assessments, subprojects, and/or areas necessary based on particular requirements of the project requirements or objectives (03-14). In one embodiment of the invention, the user creates, labels, and stores in the computerized system a series of polygons (03-15) as a data layer compatible with the standard geo-referenced database. This layer is ultimately combined, in a standard GIS approach, with the data layers contained in the PSD (03-16) supplied by the computerized system of the invention (e.g. StatPlan®).

Then, in one embodiment of the invention, the prioritization model program (03-17) is then executed for each of the project's sub-areas, and the results are presented for each relevant area in suitable summary tables. Once the prioritization model program executions have produced area prioritization based on the resources characterizing the project area, the user can then complete further analysis (03-18) utilizing the set of management actions (e.g. 03-06) identified in the initial stages of the modeling process.

### Crisis Response Support

If a user has an appropriate license, user agreements, and/or coding permits for the Crisis Response module of the computerized system for the multi-phase management of a natural disaster incident, then the computerized system can provide access to a crisis response module and an incident-specific database (ISD). In a preferred embodiment of the invention, the crisis response module includes a crisis response module operating program, a crisis response module user interface, and an incident-specific database (ISD) that is specific to the needs for incident response.

In one embodiment of the invention, because there are operational usage differences in the case of a crisis (e.g. a natural disaster) response, the database is supplied in two copies: a master copy is to be managed by only one designated administrator and a field copy is designed to serve as a primary operational base. As in a pre-incident risk reduction management phase, the database and the crisis response module (e.g. an appropriate accompanying software) is delivered using either a portable storage device or a pre-loaded computer system.

The crisis response module can be used to determine current tactical environmental information in response to a general information request or a resource allocation need, wherein the resource allocation need may be either for an initial deployment or a subsequent deployment.

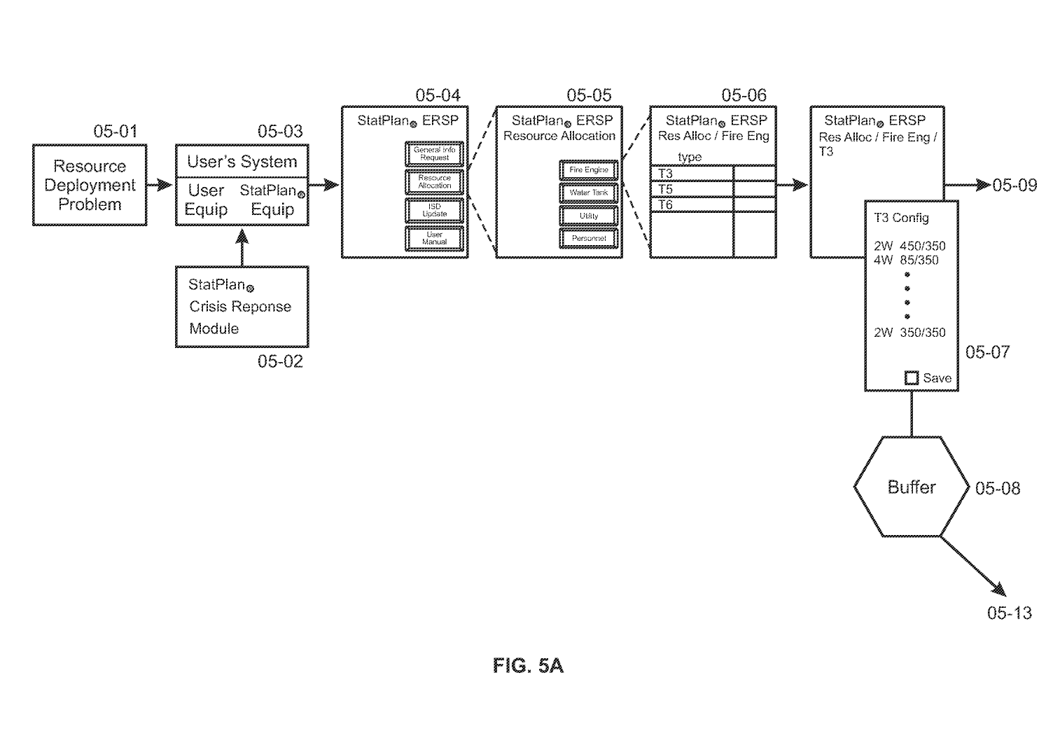

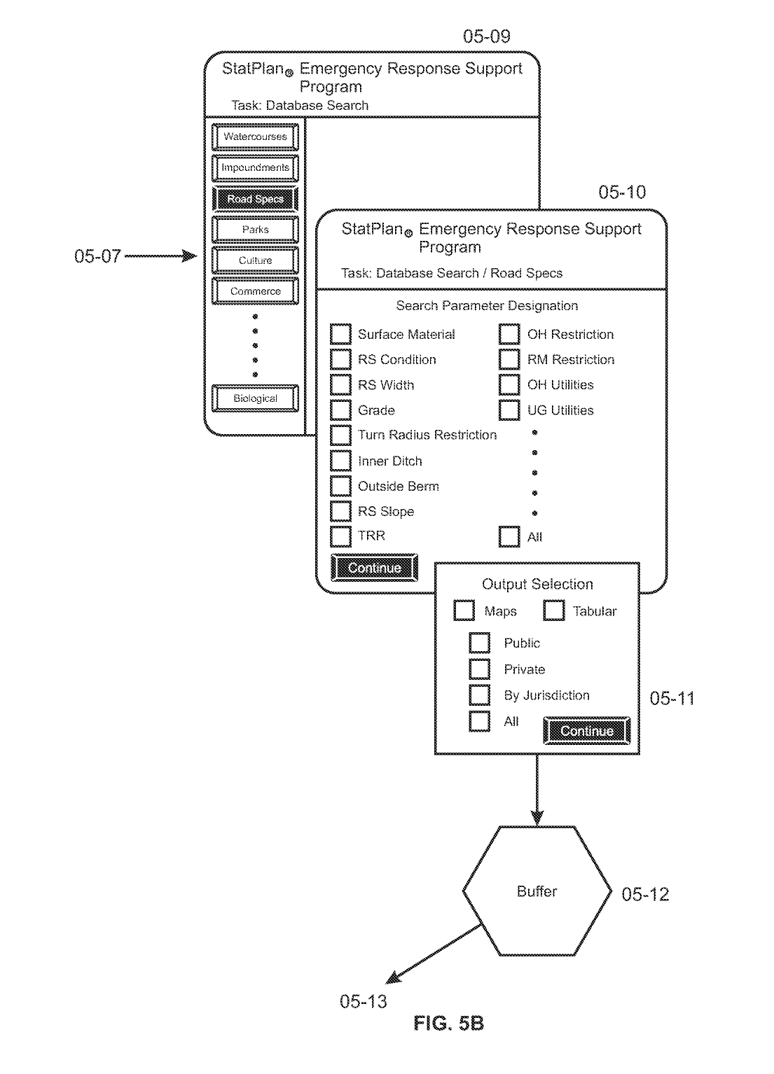

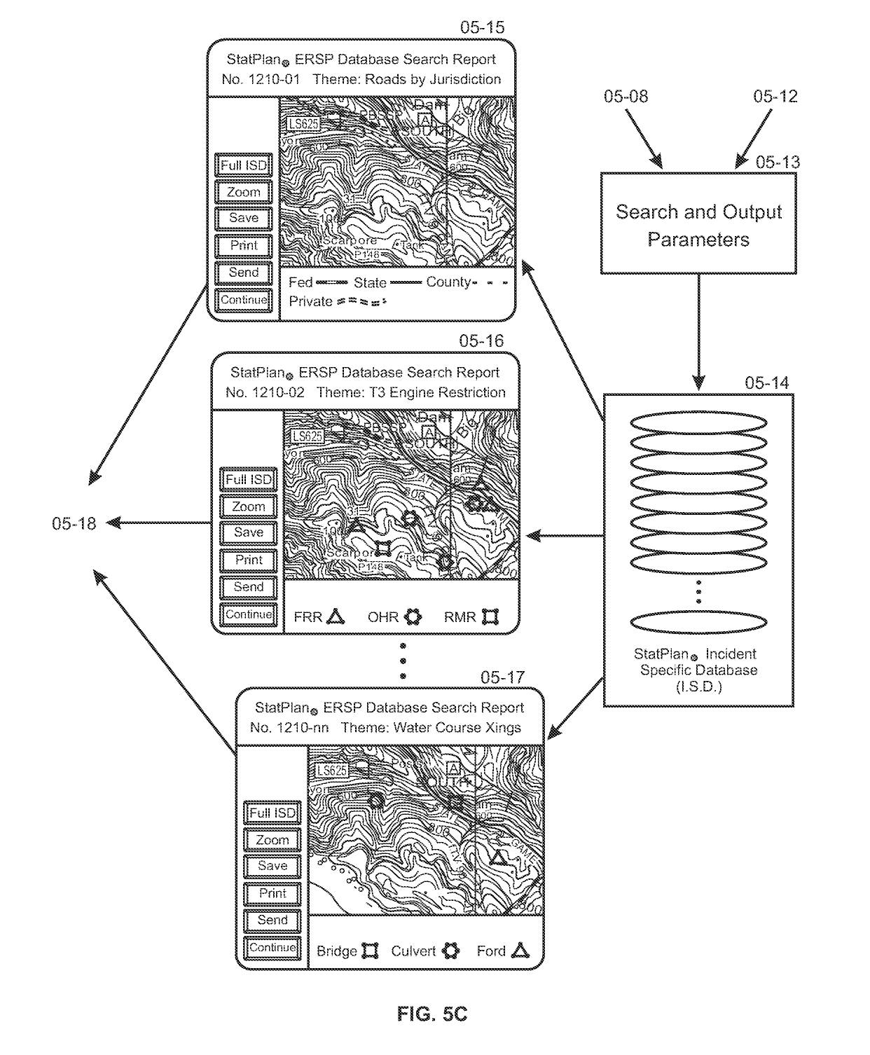

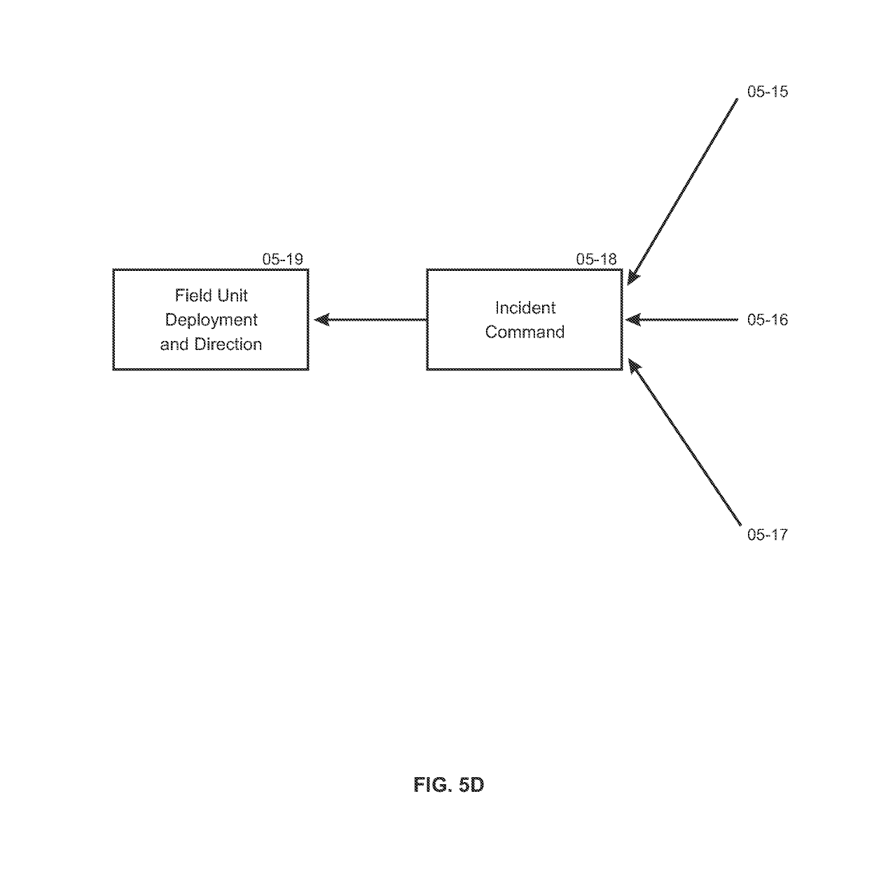

FIG. 5A˜FIG. 5D show an example of a crisis response module and related structures and procedures for a system for multi-phase management of a natural disaster incident, in accordance with an embodiment of the invention. The example illustrated in FIG. 5A˜FIG. 5D focuses on a specific deployment need (05-01). In one embodiment of the invention, an authorized user accesses the crisis response module (05-02) available on a computerized system (05-03) and selects a “Resource Allocation” request from several function activation buttons such as “General Request”, “Resource Allocation”, and “ISO Update” buttons (05-04).

In the example of FIG. 5A˜FIG. 5D, after selecting the “Resource Allocation” and “Continue” buttons, a subsequent screen in the crisis response module user interface asks the user to indicate a general category of resources which are presently available or available in the future (05-05). The crisis response module user interface can also provide a scrollable list of currently-used emergency equipment for a general category (05-06). For example, many types of similar series emergency vehicles have several variations. Once the user selects a particular series of emergency vehicles from a pull-down menu (05-07), the pull-down menu (05-07) can further allow the user to select a particular vehicle among the variations in that series of emergency vehicles. Then, once the specific resources have been identified (e.g. a variant of a Type 3 Fire Engine), the results are stored in a buffer (05-08), which ultimately leads to the definition of the full search parameter set (05-13), as shown in FIG. 5C.

Continuing with FIG. 5A˜FIG. 5D, the next task is to specify what type of tactical field conditions, or conditions utilizing subsequent query runs, need to be examined and reported for a deployment of a particular resource. The next user interface screen may show the user one or more ISD data layers which can be searched for any impact from the incident on the deployment of the resource (05-09), as shown in FIG. 5B. For example, the user can select a “roads” layer to be searched for this tactical element's effect on the deployment of the subject vehicles. A corresponding user interface screen may incorporate two pull-down menus: a first menu that allows refinement of searched attributes (05-10) such as search parameter designations related to road specifications (e.g. surface material, RS condition, RS width, grade, turn radius restriction, and etc.), and a second menu that specifies the format of the output (05-11) such as a format (e.g. map, tabular) and a type (e.g. public, private, by jurisdiction, all, and etc.) of the presentation of output This information is also stored into the indicated buffer (05-12).

The final task is to set the search area of the crisis response module to offer either a full ISD (05-14) search or a custom search, as shown in FIG. 5C. If the custom search option is selected, the user is presented with an active map of the ISD that can be geo-referenced and guided to define a polygon in which the search is to be conducted. Once the search area is identified, the program searches a database layer indicated within the defined search area. The search function of the crisis response module matches the operational attributes of the selected resource (e.g. a chosen variant of the Type 3 Fire Engine) held in the program's look-up tables (05-07) to the tactical conditions characterizing the roads present in the defined search area. The computerized system embodied by the present invention can then produce (i.e. as a result of the client's previously selected search specifications) an on-screen map (e.g. 05-15 and 05-16) showing road locations, road ownership, road traffic parameters for the specified Type 3 (T3) Fire Engine, and for roads indicated to be not currently usable, a specific location and details of the constraint. The on-screen map is preferred to be formatted as an active file which allows computerized magnification. Other options may include “Save” and “Print” functions and an additional function which converts the files to a format suitable for wireless distribution to other facilities or field units actively engaged in the response operation. Depending on the search requirements of the user, as many searches as needed can be completed, which helps yielding results for other resources, such as water sources suitable for water tender pickup (WT-WS) (05-17), shown as an example in FIG. 5C. This information can be compiled by the incident command function (05-18) and then used for field unit deployment and direction (05-19), as shown in FIG. 5D.

### Rehabilitation Management Support

The computerized system for the multi-phase management of a natural disaster incident includes a rehabilitation management module designed to assist managers addressing rehabilitation needs in a post-incident situation.

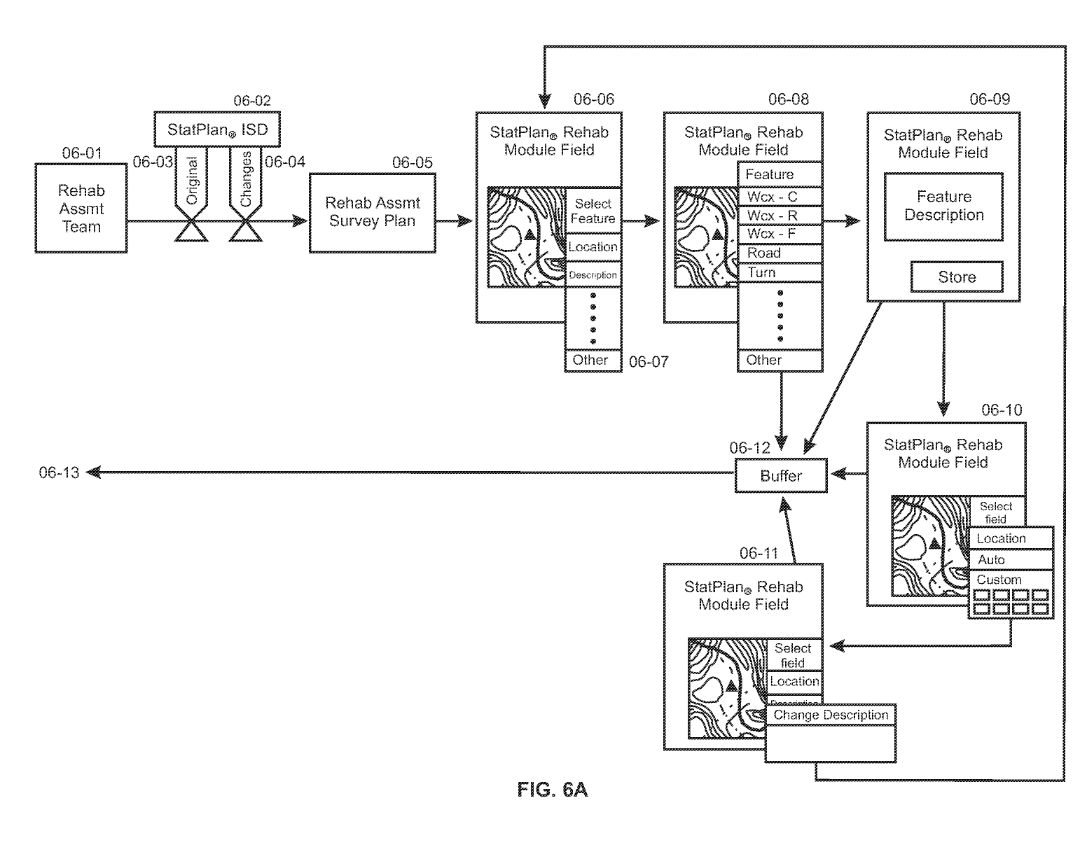

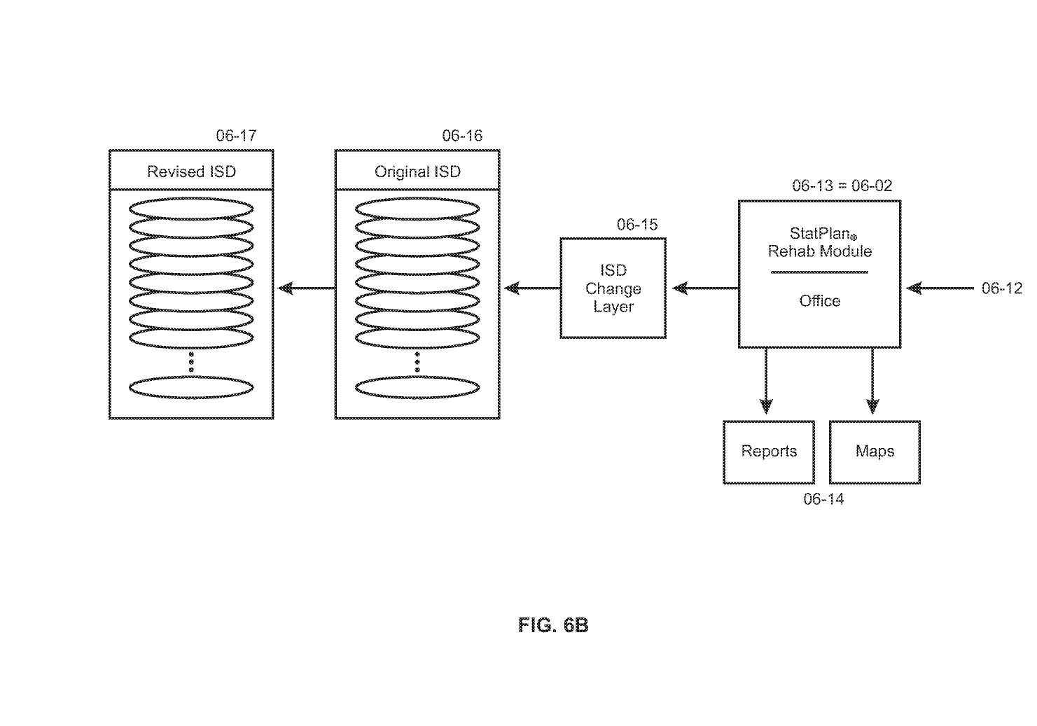

FIG. 6A and FIG. 6B show an example of a rehabilitation management module and related structures and procedures for a system for multi-phase management of a natural disaster incident, in accordance with an embodiment of the invention. In the example of FIG. 6A and FIG. 6B, a rehab assessment team is formed (06-01) which is usually a mix of local resource specialists and non-local rehabilitation experts. This team's objective is to conduct a survey of the incident area in order to assess the extent of an incident-related damage and prepare a plan for restoration and/or rehabilitation.

In a preferred embodiment of the invention, the rehabilitation management module is operatively connected to the ISD and comprises a rehabilitation management module operating program and a rehabilitation management module user interface. In the preferred embodiment of the invention, the rehabilitation management module is delivered in two versions: an office version and a field version. In addition to the rehabilitation management module operating program and the rehabilitation management module user interface, the office version (06-02) may also include map and aerial image layers, software routines allowing the integration of user supplied information and data layers (e.g. a burnt area in a wildfire) which are managed by the rehabilitation management module operating program, and an analytical program to analyze the collected field data to generate a report. In one embodiment of the invention, the rehabilitation management module operating program integrates the analytical program. In another embodiment of the invention, the rehabilitation management module operating program is operatively linked to the analytical program.

The office version is delivered via a computer-readable storage medium or via a pre-loaded computer. The survey team can assess the available information, including an impact of the incident (06-04) and the pre-incident conditions (06-03) provided by the ISD. In the example of FIG. 6A and FIG. 6B, the survey team also prepares its rehab assessment survey plan (06-05). Preferably, one or more survey team units deploy into the field with portable computers loaded with the field version (06-06) of the rehabilitation management module of the computerized system for multi-phase management of a natural disaster incident. This field version (06-06) is loaded with navigation assistance information (e.g. maps and aerial images) and step-by-step procedures for recording standardized data into a computer-readable storage medium operatively connected to the rehabilitation management module.

Continuing with FIG. 6A and FIG. 6B, an initiation of the rehabilitation management module operating program in the field brings up a user interface screen which shows a live map or an aerial image. In a preferred embodiment of the invention the user interface screen is provided by the rehabilitation management module user interface and links to other program functions (06-07). A computer system or terminal used by a survey team personnel may be custom-designed and/or at least incorporates a GPS-based automated location tracker so that the survey team is able to monitor the personnel's progress in the incident area.

In the example presented in FIG. 6A and FIG. 6B, a “Feature” link is initiated after reaching a condition or feature requiring notation which allows the user to identify, or describe, the subject feature. Selecting the “Feature” link initiates a pull-down menu (06-08) with a list of standard features and an accompanying code which provide access to data contained in the prime database and the ISD. If the list shows an appropriate feature description, the user can press the “Continue” button to begin recording of relevant field data, typically in the incident area. A unique code can be automatically assigned to the record, and the record can be stored in a program buffer (06-12). On the other hand, if a feature is not adequately represented on the standard list the user has the option to select “other feature” button. This selection results in a user interface screen that allows the user to describe the feature and then store this custom information as a feature description (06-09). Similar to the previous case, a unique code can be automatically assigned to the record containing information under the “other feature” category, and the record can be stored in a program buffer (06-12).

Then, if a user selects the “Location” link as shown in a screenshot (06-10), then a “drop-down” panel appears which allows the user to select the “Auto” input or record custom coordinates. The “Auto” function uses the geographical location indicator (e.g. GPS), generally mounted in a field personnel's vehicle, and stores the location data into a buffer as the feature location. If the feature is not at the location of the vehicle-mounted geographical location indicator, then the feature location can be determined by some other methods (e.g. a hand held GPS receiver, map, a survey team member's location update on a StatPlan® map, etc.) and entered into the spaces provided by the user. The feature location can be stored into the buffer (06-12).

Continuing with FIG. 6A and FIG. 6B, the user interface screen can also allow the user to enter more detailed information regarding the condition of the feature and recommendations for restoration or rehabilitation (06-11). Once a particular recording of the field data by a survey team personnel is complete, the user interface screen driven by the rehabilitation management module brings the user back to the original panel in preparation for the next record.

Back in the incident command (IC) office, the stored contents of the buffer are loaded into the office version of the rehabilitation management module (06-13) and are used to prepare a full record of field actions as an addendum to a rehabilitation/restoration report and part of the permanent project record. Reports and figures are generated as needed to support the recommendations made in the final rehabilitation/restoration report (06-14). Lastly, in the example of FIG. 6A and FIG. 6B for a rehabilitation management scenario, the information contained in the buffer is formulated into an ISD change layer (06-15) and applied to the original ISD (06-16) by an appropriate administrator for a revised ISD (06-17).

From this point forward implementation of the rehabilitation/restoration plan is essentially similar to a pre-incident phase implementation of the present invention, and the pre-incident module can be used in conjunction with the rehabilitation management module.

### The System Communication Function

In an evolving natural disaster, the tactical environment can change significantly over a short period of time. These types of changes can require the rapid re-direction of resources in the process of being deployed and may put already-deployed resources at serious risk. Rapid dissemination of clear and easily-interpretable command directions is key to a crisis response situation. The computerized system for multi-phase management of a natural disaster incident is devised to operate in a manner consistent with the current communications specifications utilized by emergency organizations. In addition, in a preferred embodiment of the invention, the computerized system for multi-phase management of a natural disaster incident incorporates a “mirror” approach which makes the same “hard” data set is available to both the incident command (IC) and field units. The “hard” data set becomes a common element that reduces the need for interpreting the meaning or intent of a directive communication. For example, if IC determines movement of certain field units is necessary due to heightened risk, it can analyze fresh information from the prime database, the ISD, and/or the PSD and identify a rendezvous site and broadcast the directive to the units involved. The units then can access the ISD on their on-board computer, identify the appropriate rendezvous point, and then using the information contained within the ISD to plan their route to the point.

### The System Update Function

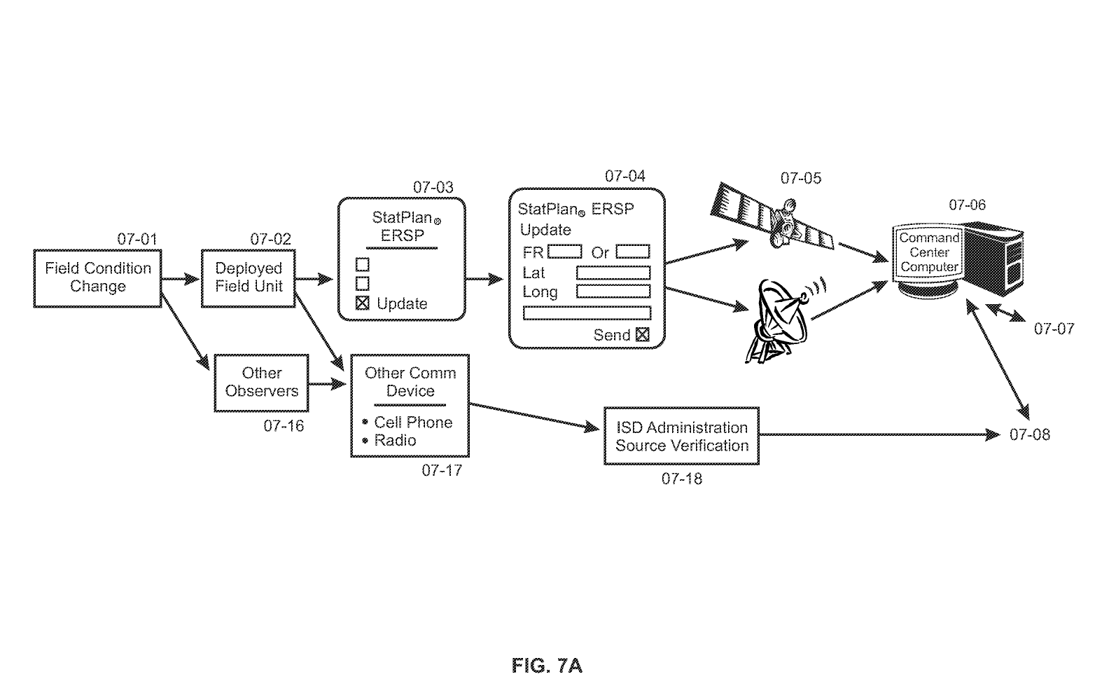

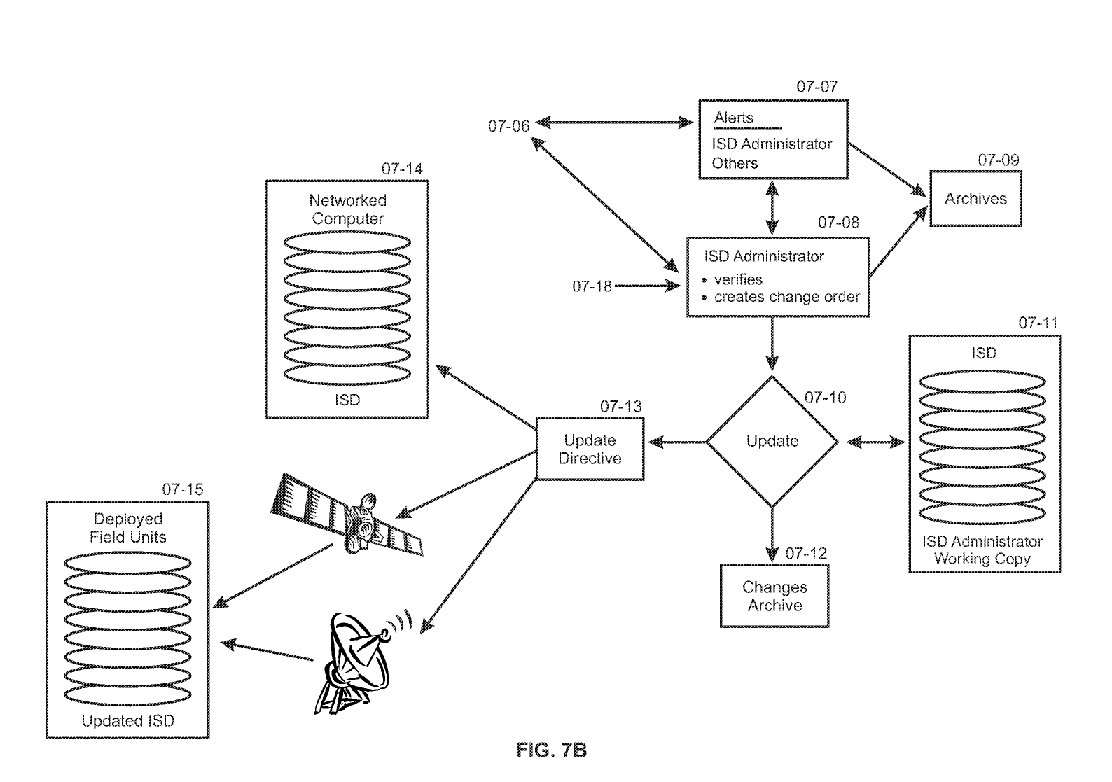

Because rapid changes are common in most disaster-related activities, one of the most critical changes is related to real-time resource deployment decisions. The computerized system for multi-phase management of a natural disaster incident, as embodied by the invention, is developed to include communication and database update routines so that the required changes can be made with minimal delays. FIG. 7A and FIG. 7B show an example of an update function and related procedures for a system for multi-phase management of a natural disaster incident, in accordance with an embodiment of the invention.

In a preferred embodiment of the invention, an initiating event for starting the ISD update process is an observed change in some elements of the tactical environment within an incident area (e.g. 07-01). The computerized system routines have been designed to accept change observations in multiple ways. The principal way is through communications loops with appropriately equipped field units that have been deployed as part of the incident response (07-02). Upon observing a change in the tactical environment that has ramifications for the continuing response effort, a designated field unit team member accesses the programs associated with the computerized system for multi-phase disaster management in the field.

In the preferred embodiment of the invention, the initial user interface screen can offer the user access to several function packages. “Database Update” may be one (07-03) option. Selecting this option passes the user to a user interface screen that allows entry of information concerning the observed change (07-04). For example, this user interface screen can accept entry of the geographical coordinates of the tactical element that has changed and offers a pull-down of common changes as well as space for descriptive text regarding the change. Upon completing the entries the user pushes the “Send” button, and this action sends (07-05) the message, coded with a unique tag indicating the field unit designator, the date and time of transmission, and geographical coordinates of the field unit at the time of transmission to a buffer in the computerized system for multi-phase management of a natural disaster incident at the command/control (e.g. incident command) facility (07-06).

In one embodiment of the invention, the receipt of an update communication triggers both an audible and visual alert on the receiving computer. An alert message is sent to one or more designated workstations in the incident command center (07-07). Upon receipt of the alert, the ISD administrator, or designee, opens the buffer, confirms that the message is correct by checking the tag information, and initiates the update to the operational version of the ISD (07-08). The administrator also stores the message into a permanent file that becomes a part of the incident project folder (07-09). Using the tactical information type description and the geographical coordinates the administrator locates the feature in the appropriate location in the working copy of the ISD (07-10) and changes the attribute files to reflect the new condition in an ISD administrator working copy of the ISD (07-11). The change operation is documented and automatically stored into a buffer that will contain the full set of changes made, which again, will ultimately become a part of the incident record (07-12). The administrator then prepares an update directive (07-13) that is automatically sent to all relevant computers, both in the command center (07-14) and in the field (07-15). In one embodiment of the invention, the update directive contains the attribute address and change type. Upon receipt of the order in all relevant computers, an auto-update routine contained within the program is initiated and the change is made system-wide.

The computerized system for multi-phase management of a natural disaster incident can also accept change requests from sources other than identifiable field units (07-16). Change information can be accepted via phone or radio communication (07-17). The administrator, or another designee, accepts the communication and documents the required information on forms provided. The administrator handling the communication is required to request and document information related to the authenticity of the source. If the source is determined to be valid (07-18), then the change is made and distributed in the same manner as changes from identifiable field units.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A system for multi-phase management of a natural disaster incident, the system comprising:
at least one CPU operatively connected to a memory unit;
a pre-incident module operatively connected to a project-specific database (PSD) and a computer-readable storage medium, wherein the pre-incident module comprises a pre-incident module operating program, a pre-incident user interface, a prioritization model user interface, and a prioritization model program for a planning prioritization model, wherein the prioritization model program is capable of deriving a sub-area index value (SAIV), which is a quantitative measure of priority for pre-incident planning derived from an environmental parameter (EP), a weighting factor (WF) parameter, and a quantitative representation of the environmental parameter (QREP) for a specific area from the PSD;
a crisis response module operatively connected to an incident-specific database (ISD) and the computer-readable storage medium, wherein the crisis response module comprises a crisis response module operating program, a crisis response module user interface, and an ISD update interface unit; and
a rehabilitation management module operatively connected to the ISD and the computer-readable storage medium, wherein the rehabilitation management module comprises a rehabilitation management module operating program and a rehabilitation management module user interface.

2. The system for multi-phase management of the natural disaster incident of claim 1, further comprising a prime database configured to store one or more geo-referenced layers for emergency management and response, wherein each geo-reference layer contains one or more geographic and resource-specific information to be referenced, superimposed, and/or used by a general topographical database for creation of the PSD and the ISD.

3. The system for multi-phase management of the natural disaster incident of claim 1, wherein the pre-incident user interface allows a user to select a particular risk type from a list of risk types and a set of industry standard management actions associated with the particular risk type.

4. The system for multi-phase management of the natural disaster incident of claim 1, wherein the crisis response module user interface is capable of taking a general request, a resource allocation request, or an ISD update request from a user.

5. The system for multi-phase management of the natural disaster incident of claim 4, wherein the resource allocation request involves allowing a user to choose emergency equipment from a list of available equipment, a particular tactical filed condition for viewing, and a specific search area for equipment deployment.

6. The system for multi-phase management of the natural disaster incident of claim 1, wherein the rehabilitation management module user interface provides pre-incident condition information and post-incident condition information after the natural disaster incident is in a rehabilitation stage.

7. The system for multi-phase management of the natural disaster incident of claim 1, wherein the rehabilitation management module user interface is capable of recording standardized data in the rehabilitation management module from a user's input entry for a potential update in the ISD.

8. The system for multi-phase management of the natural disaster incident of claim 2, wherein the one or more geographic and resource-specific information include a theme and an attribute specific to the theme.

9. The system for multi-phase management of the natural disaster incident of claim 2, wherein the project-specific database (PSD) or the incident-specific database (ISD) contains a data-layer set comprising at least some geo-referenced layers derived from the prime database for a specific geographic region requested by a user through a user interface for the system.

10. The system for multi-phase management of the natural disaster incident of claim 9, wherein the data-layer set of the PSD or the ISD is created in part by clipping and stitching relevant data sets from the prime database.

11. The system for multi-phase management of the natural disaster incident of claim 1, wherein at least some geo-referenced layers are based on standard USGS map information.

12. The system for multi-phase management of the natural disaster incident of claim 1, further comprising an ISD update unit which receives and authenticates an ISD update request from a user and processes the ISD update request by updating an operational version of the ISD and storing a record of the ISD update in an incident record.

13. The system for multi-phase management of the natural disaster incident of claim 12, wherein the ISD update unit also updates any relevant computers associated with the system if local data in the relevant computers require program updates.

14. The system for multi-phase management of the natural disaster incident of claim 8, wherein the theme is a land jurisdiction pattern, road information, vegetation formations, water infrastructure, wildlife habit, geologic or soils hazards, waste disposal infrastructure, energy infrastructure, communications infrastructure, commercial infrastructure, cultural resources, emergency response infrastructure, or emergency services infrastructure, and wherein the attribute is a more descriptive field under the theme.

15. A data processing system for multi-phase management of a natural disaster incident, the data processing system comprising:
at least one CPU operatively connected to a memory unit;
a pre-incident module operatively connected a project-specific database (PSD) and a computer readable storage medium, wherein the pre-incident module comprises a pre-incident module operating program, a pre-incident user interface, a prioritization model user interface, and a prioritization model program for a planning prioritization model, wherein the prioritization model program is capable of deriving a sub-area index value (SAIV), which is a quantitative measure of priority for pre-incident planning derived from an environmental parameter (EP), a weighting factor (WF) parameter, and a quantitative representation of the environmental parameter (QREP) for a specific area from the PSD;
a crisis response module operatively connected to an incident-specific database (ISD) and the computer readable storage medium, wherein the crisis response module comprises a crisis response module operating program, a crisis response module user interface, and an ISD update interface unit;
a rehabilitation management module operatively connected to the ISD and the computer readable storage medium, wherein the rehabilitation management module comprises a rehabilitation management module operating program and a rehabilitation management module user interface; and
an ISD update unit which receives and authenticates an ISD update request from a user and processes the ISD update request by updating an operational version of the ISD and storing a record of the ISD update in an incident record.

16. The data processing system of claim 15, further comprising a prime database configured to store one or more geo-referenced layers for emergency management and response, wherein each geo-reference layer contains one or more geographic and resource-specific information to be referenced, superimposed, and/or used by a general topographical database for creation of the PSD and the ISD.

17. The data processing system of claim 15, wherein the pre-incident user interface allows a user to select a particular risk type from a list of risk types and a set of industry standard management actions associated with the particular risk type.

18. The data processing system of claim 15, wherein the crisis response module user interface is capable of taking a general request, a resource allocation request, or an ISD update request from a user.

19. The data processing system of claim 18, wherein the resource allocation request involves allowing a user to choose emergency equipment from a list of available equipment, a particular tactical filed condition for viewing, and a specific search area for equipment deployment.

20. The data processing system of claim 15, wherein the rehabilitation management module user interface provides pre-incident condition information and post-incident condition information after the natural disaster incident is in a rehabilitation stage.

21. The data processing system of claim 15, wherein the rehabilitation management module user interface is capable of recording standardized data in the rehabilitation management module from a user's input entry for a potential update in the ISD.

22. The data processing system of claim 16, wherein the project-specific database (PSD) or the incident-specific database (ISD) are created in part by clipping and stitching relevant data sets from the prime database, and wherein the PSD or the ISD contains a data-layer set comprising at least some geo-referenced layers derived from the prime database for a specific geographic region requested by a user through a user interface for the system.
